(19) United States
(12) Patent Application Publication
(10) Pub. No.: US 2004/0006534 A1
(43) Pub. Date: Jan. 8, 2004

(54) Method and system for managing credit-related and exchange rate-related risk

(76) Inventor: Ka Shun Kevin Fung, Hong Kong (HK)

Correspondence Address: SAWYER LAW GROUP LLP, P.O. Box 51418, Palo Alto, CA, 94303, US

(21) Appl. No.: 10/600,903

(22) Filed: Jun. 19, 2003

Related U.S. Application Data
(60) Provisional application No. 60/389,956, filed on Jun. 20, 2002.

(51) Int. Cl. G06F 17/60

(52) U.S. Cl. 705/38

(57) ABSTRACT

A method and system for managing risk for contracts offered for trading in systems is disclosed. A complete set of contracts includes the contracts, each of which matures upon event(s) occurring. The complete set guarantees at least an initial settlement value at at least one particular time. The complete set also corresponds to a settlement value, which is based upon the initial settlement value and an, preferably, interest rate effect, if any. A winning contract pays a notional upon maturing. Rate differential(s) between systems, and hedging costs exist. In one aspect, the method and system include determining whether a matching trade in a second system for a trade in a first system is possible, determining whether conducting the trades is profitable and, if so, performing these trades. In another aspect, the method and system determine whether individually selling the contract(s) is profitable given the rate differential. If so, the method and system also include obtaining the complete set and individually selling the contract(s). In another aspect the method and system include determining whether assembling the complete set is profitable given the rate differential. If so, the method and system include assembling the complete set and exchanging the complete set for the settlement value.

### CROSS-REFERENCE TO RELATED APPLICATIONS

This application is claiming under 35 USC 119(e) the benefit of provisional patent application serial No. 60/389,956 filed on Jun. 20, 2002.

The present application is related to co-pending U.S. patent application Ser. No. (2626P), entitled “METHOD AND SYSTEM FOR IMPROVING THE LIQUIDITY OF TRANSACTIONS” filed on ______. The present application is also related to co-pending U.S. patent application Ser. No. (2700P), entitled “METHOD AND SYSTEM FOR UTILIZING A SPECIAL PURPOSE VEHICLE FOR IMPROVING THE LIQUIDITY OF TRANSACTIONS” filed on ______.

### FIELD OF THE INVENTION

The present invention relates to financial instruments, and more particularly to a method and system for improving the liquidity of transactions, preferably using a computer system.

### BACKGROUND OF THE INVENTION

A variety of financial instruments, or contracts, are currently traded in many different markets. These contracts could take a variety of forms and be related to a variety of activities. For example, the contracts could range from options and futures to betting. Participants in the markets place bids (offers to buy contract(s)) and offers (offers to sell contract(s)). Each offer and bid has a price limit associated. The participants in the market could include individual participants, financial intermediaries, or market makers, such as brokerage houses or banks. Furthermore, the buyers and sellers could be short or long. For example, a long seller is a seller already having a position in the market and holding the contract for which the seller made an offer. A short seller is a seller who does not yet have ownership of the contract being offered for short sale. Similarly, a buyer may be making a bid to cover a contract previously offered for sale. In the case of betting, in buying a contract, a buyer may simply be making a bet. Similarly, a seller of a contract in betting is typically a bookmaker. Systems such as www.betfair.com and www.intrade.com allow customers to buy multiple contracts (bets) as a set, which appear to guarantee a particular return. However, if the event(s) on which the user is betting do not take place or have another unusual outcome, the customer has little recourse. At best, a refund of the bettor's investment might be provided. In addition, interest rate effect is usually not accounted for, potentially resulting in unnecessary financing cost incurred by the bettors. As a result, relationships between buyers, sellers, individual participants and market makers may be complex. Furthermore, unnecessary uncertainty may be created in these relationships, which indirectly increases trading costs. In addition, the market in which the participants act could be a traditional exchange, a bookmaking enterprise such as a casino, or other similar market.

Typically, the interaction between the market participants can take place via three conventional structures: conventional order matching, conventional market making, and conventional auctions. In conventional order matching, bids and offers are centralized, typically in an exchange. Individual participants can then buy or sell until an equilibrium for a particular contract is reached. Typically, the exchange takes no risk in the market. In conventional market making, a market maker takes a position opposite to other market participants. Thus, a market maker may sell or buy contracts to other market participants. In conventional auctions, a contract is typically offered for sale to any market participant. Conventional auctions can take a variety of forms. In certain conventional auctions, the contract is initially offered at a high price. The price is progressively lowered until a bid is made and the contract is sold. In conventional Dutch auctions, the lowest price necessary to sell the entire lot of contracts becomes the price at which the contracts are sold.

Regardless of the structures used, the market can be viewed as coming to an equilibrium when the prices for all bids for a particular contract are less than prices for all offers for the contract. In other words, no bid is high enough (or conversely no offer is low enough) for a transaction to take place and the contract to be sold. As a result, no more transactions will take place for the contract until a new bid and/or new offer that bridge the gap between the bids and offers is made.

Although conventional structures allow transaction to take place and for the market to reach an equilibrium, conventional methods for allowing transactions have drawbacks. First, the conventional structures may not result in a high degree of liquidity. Typically, liquidity can be measured in three ways: bid/offer spread, volume and price discovery. The bid/offer spread is an instantaneous measurement of liquidity. The bid/offer spread is the difference between the highest bid and lowest offer for a particular contract at a particular instant in time. The higher the bid offer spread, the lower the liquidity because the less likely that a market participant will be able to sell or buy the contract. The volume can be considered to be the time required to have an order for a contract filled or the volume of transactions for a given unit of time. The shorter the time required to fill an order and the higher the volume of transactions, the greater the liquidity and the easier it would be for a market participant to enter or leave the market. Price discovery is the ability to discover the true price of a contract in the market that has reached equilibrium. The easier it is to discover the price of a contract, the higher the liquidity. Thus, conventional structures such as order matching may result in a higher bid/offer spread, a lower volume of transactions, and more difficulty in determining the actual price of the contracts.

A high liquidity is desirable. A higher liquidity allows the market participants to move in and out of the market more easily. In addition, exchanges desire a high liquidity because exchanges typically obtain a profit based upon the number of transactions carried out. The higher the liquidity is, the higher the number of transactions and the greater the profit of the exchange. Market makers desire a higher liquidity because a high liquidity translates to a higher number of transactions, lower risk for the market maker and a lower cost of borrowing capital for the market maker. Thus, it would be desirable for a higher liquidity in the market place than may be available using the conventional structures for performing transactions.

In addition, the conventional structures of conventional order matching, market making and auctions performed in the conventional manner described above have other drawbacks. Conventional order matching often does not function well when there is an insufficient number of sellers that actually have contract(s) to sell, as opposed to a short seller. As a result, there will be lowered liquidity. In some situations, conventional market makers may actually have an incentive to reduce the competitive nature of the marketplace because the market maker may act to their own advantage, rather than to the advantage of the market as a whole. Conventional auctions take time to set up and identify winner(s).

Furthermore, the type of contract (or financial instrument) described above, financial instruments defined by the same underlying event (such as a sporting event), or financial instruments associated with a continuous variable (such as the price of gold) can be associated with different costs depending upon the system in which the contract is traded. As used herein, the same type of contract has a corresponding final payout for the same outcome across different systems. For example, for two contracts of the same type in two different systems, if one contract is a winner in a first system, the other contract will also be a winner in the second system. This feature applies to all and any situations, including exceptional circumstances such as none of the contract outcomes happening, when the settlement value will be distributed to contracts in the set in a pre-determined way. Such a distribution would be identical across the same type of contracts in different systems. The costs for trading a contract in different systems may fluctuate. Similarly, the expected return may also differ. For example, for the same type of contract, a U.S. dollars (USD) contract set may have a settlement value of US$100, while a Yen contract set will have a settlement value of 100 yen. Thus, the payouts for the same contract type in different systems (U.S. dollar based and Yen based) are different and may fluctuate depending on factors such as the exchange rate. Consequently, the risks of trading contracts across these systems may also fluctuate. Stated differently, there is a rate differential between two systems that can fluctuate even though the same type of contracts are traded. For example, different systems may be based upon different currencies, but trade the same type of contracts. One or more bids and/or offers for USD contracts may, therefore, exist on the New York Stock Exchange (NYSE), which also uses U.S. dollars as a currency for quotation purpose. One or more bids and/or offers may exist for the Yen contracts, albeit different quantities, on the Tokyo Stock Exchange (TSE), which also uses yen as a currency for quotation purpose. The exchange rate between dollars and yen fluctuates continually. There is, therefore, a fluctuating cost of making trades (buying or selling) on each of the systems. Furthermore, there is a fluctuating cost of making a trade on one system and making a trade on another system. For example, a market participant may buy a USD contract on one system (e.g. the NYSE) and sell the Yen contract of the same type on another system (e.g. the TSE). Based upon different factors such as the price of each trade, the time at which each trade is made, the associated exchange rates, and the outcomes of the contracts, the profit or loss of the market participant may change.

Similarly, different systems may be associated with different credit risks. The credit risk for a particular system corresponds to the probability that the settlement value payable to the contract holders on that system will not be honored. For example, subsystems of a particular exchange may have an inferior credit rating because it may be more likely that a trade on the subsystem will not be honored. The credit rating of a particular system may also fluctuate. The credit rating of a system translates into a cost of trading on the system. Thus, trading contracts on different systems is also associated with a changing rate differential that is based upon the credit rating of the system. Based upon different factors such as the price of each trade, the time at which each trade is made, the outcomes of the contracts, and the credit ratings of each system, the profit or loss of a market participant making trades on the systems can change.

Market participants account for this risk using hedging. A market participant may buy hedging instruments, such as options, to account for risks, such as risks due to exchange rates or credit risks. Such hedging instruments have a cost, termed a hedging cost. The hedging cost is based upon the rate differential between the systems in which the contracts are traded, the contract price, the notional value, and/or the settlement value of the contract set to which the contract belongs. For example, for exchange rates, the hedging instrument would allow the holder to surrender certain currencies (such as yen) for other currencies (such as dollars) at a particular exchange rate. Such a hedging instrument would be a dollar call/yen put at a strike price corresponding to the exchange rate. The amount of the option would be equal to the risk to which the market participant is exposed. Thus, the holder of the hedging instrument would have the right, but not obligation to receive dollars for surrendering yen at the appropriate exchange rate. Similarly, for credit risks, the market participant is at risk of the seller or issuer of the contract of the systems not honoring the contract. If the corresponding exchange for the second system does not pay, for example because it is bankrupt, then the market participant has a risk. The market participant can account for this risk through another hedging instrument having a hedging cost. In this example, the hedging instrument might be a letter of credit or other guarantee. The amount of the hedging instrument required would be equal to the risk to which the market participant is exposed.

Although a market participant can make such trades, there are several drawbacks. In order to determine the profit, a market participant would have to determine the hedging cost. In addition, a market participant might not be aware of trades available in other systems. Thus, the market participant may not make trades, may not adequately manage the risk, and liquidity may not be improved.

Accordingly, what is needed is a system and method for improving the trading of contracts subject to risks, such as exchange rate or credit related risks. The present invention addresses such a need.

### SUMMARY OF THE INVENTION

The present invention provides a method and system for managing risk for a plurality of contracts offered for trading in plurality of systems. A complete set of contracts includes the plurality of contracts. The complete set guarantees at least an initial settlement value at at least one particular time. The complete set also corresponds to a settlement value, which is based upon the initial settlement value. In a preferred embodiment, the settlement value is also based on an interest rate effect, if necessary. In addition, rate differentials, which result in hedging costs, exist between the systems. In one aspect, the method and system include determining whether a matching trade for the contract is possible in a second system of the plurality of systems. In this aspect, the method and system also include determining whether conducting a portion of the trade and a portion of the matching trade is profitable and, if so, performing the portion of the trade and the portion of the matching trade. In another aspect, the method and system include determining whether it is profitable to individually sell the contract and a portion of the plurality of contracts. The portion of the plurality of contracts corresponding to at least one bid, if any. The at least one bid is in at least a second system corresponding to at least one rate differential between the first system and the at least the second system. The at least one rate differential results in the at least one hedging cost between the first system and the at least the second system. In this aspect, the method and system also include obtaining the complete set of contracts, if profitable, and individually selling the contract and the portion of the plurality of contracts, if profitable. In another aspect, the method and system include determining whether individually buying the contract at the particular price and a remaining portion of the plurality of contracts is profitable. At least one offer exists in at least a second system. Thus, at least one rate differential exists between the first system and the at least the second system. The rate differential results in the at least one hedging cost between the first system and the at least the second system. In this aspect, the method and system also include assembling the complete set by buying the contract and the remaining portion of the plurality of contracts, if required or profitable. In this aspect, the method and system also include exchanging the complete set for the settlement value, if profitable.

According to the system and method disclosed herein, the present invention provides improved liquidity and allows risk, such as risk due to exchange rates or credit ratings, to be managed. In particular, trades can be made and profit attained based upon differentials in currencies and credit ratings and based upon the settlement value of a complete set of contracts.

### BRIEF DESCRIPTION OF THE DRAWINGS

FIG. 1A is a diagram depicting one embodiment of a special purpose vehicle in accordance with the present invention interacting with market participants in different systems.

FIG. 1B is a diagram depicting another embodiment of a special purpose vehicle in accordance with the present invention interacting with market participants in different subsystems.

FIG. 1C is a block diagram of one embodiment of a system in accordance with the present invention for managing risks.

FIG. 2 is a high level flow chart of one embodiment of a method in accordance with the present invention for managing risks by matching transactions.

FIG. 3A is a more-detailed flow chart depicting one embodiment of a method in accordance with the present invention for managing risks by selling contracts.

FIG. 3B is a more-detailed flow chart depicting one embodiment of a method in accordance with the present invention for managing risks by buying contracts.

FIG. 4 is flow chart depicting one embodiment of a method in accordance with the present invention for managing risks by making conditional orders.

FIG. 5 is a flow chart depicting one embodiment of method in accordance with the present invention for managing risks based on adjustments in the risks between systems.

FIG. 6 is a flow chart depicting one embodiment of a method in accordance with the present invention for managing risks based on adjustment in risks between systems by adjusting the strike.

FIG. 7 is a flow chart depicting one embodiment of a method in accordance with the present invention for managing risks based on adjustment in risks between systems by adjusting the strike and keeping delta neutral.

FIG. 8 is a flow chart depicting one embodiment of a method in accordance with the present invention for managing risks based on adjustment in risks between systems by performing rolling of hedging instruments.

FIG. 9A depicts a high level flow chart of one embodiment of a method in accordance with the present invention for converting certain financial instruments into a complete set.

FIG. 9B depicts a high level flow chart of one embodiment of a method in accordance with the present invention for converting contract orders into other financial instruments.

### DETAILED DESCRIPTION OF THE INVENTION

The present invention relates to an improvement in transactions involving financial instruments. The following description is presented to enable one of ordinary skill in the art to make and use the invention and is provided in the context of a patent application and its requirements. Various modifications to the preferred embodiment will be readily apparent to those skilled in the art and the generic principles herein may be applied to other embodiments. Thus, the present invention is not intended to be limited to the embodiment shown, but is to be accorded the widest scope consistent with the principles and features described herein.

The present application is related to co-pending U.S. patent application Ser. No. (2626P), entitled “METHOD AND SYSTEM FOR IMPROVING THE LIQUIDITY OF TRANSACTIONS” filed on ______. The present application is also related to co-pending U.S. patent application Ser. No. (2700P), entitled “METHOD AND SYSTEM FOR USING A SPECIAL PURPOSE VEHICLE FOR IMPROVING THE LIQUIDITY OF TRANSACTIONS” filed on ______. Applicant hereby incorporates by reference the above-identified co-pending patent applications.

Using the method and system described in the above-identified co-pending applications, liquidity of transactions (or of the contracts that are the subject of the transactions) is improved. The method and system preferably deals with the kinds of contracts described above. Each contract in the complete set matures upon a particular event or events and might be bought or sold individually. The contracts could be concerning a wide variety of subjects. Such contracts include but are not limited to options, futures, and bets. In a preferred embodiment, each contract is discrete. A discrete contract is one which, upon maturing, either wins or loses. Thus, the payment a holder of the contract is due upon maturing is either positive (for a winning contract) or zero (for a losing contract). For example, if the contract is a bet on a particular sporting event, upon expiration of the sporting event, a holder of the contract has either won or lost. Thus, the outcome for such a contract can be considered to be a yes/no or true/false type of outcome. However, the payment amount which the holder of the contract is entitled to may vary. For example, one such contract may entitle its holder to be paid a variable amount conditional upon whether the actual price of the stock is higher than a predetermined price level (the strike price of the call option) at a particular time. The particular time can be considered to be the event upon which the contract matures. If, at the particular time, the stock has an actual price that is higher than the strike price, then the contract wins. However, the total amount that the holder is due depends upon the difference between the actual price of the stock and the strike price of the option. Moreover, such variable amount is usually subject to a predetermined “ceiling” (the capped amount for call spread or capped call option).

The method and system described in the above-identified co-pending applications define a complete set of contracts including a plurality of contracts. The complete set guarantees at least an initial settlement value at at least one particular time. The complete set also corresponds to a settlement value that is determined based upon the initial settlement value and, in a preferred embodiment, an interest rate effect, if desired. Thus, the settlement value is preferably the initial settlement value with the time value of money accounted for, if desired. In a preferred embodiment, the complete set guarantees exactly the initial settlement value. In a preferred embodiment, the contracts in the complete set are not only discrete but also mutually exclusive and collectively exhaustive. Because the contracts are mutually exclusive, if one contract in the complete set is a winning contract, no other contract in the complete set will be a winning contract. Because the contracts are collectively exhaustive, all possible outcomes are represented by the complete set of contracts. However, the contracts in the complete set need not be mutually exclusive and/or collectively exhaustive. In order to define the complete set, the method and system described in the above-identified co-pending applications monitor the marketplace or exchange to determine candidates for the complete set. For example, for options, candidates for the complete set might include a put and a call for a particular option. If the complete set of contracts is based upon sporting event(s), candidates for the complete set include the outcome(s) of the sporting events. If the contracts are for a commodity, then candidates for the complete set include price ranges for the commodity. Based on the candidates found, the complete set can be determined.

The settlement value for the complete set is preferably guaranteed regardless of the price of each contract. In addition, the settlement value is preferably guaranteed regardless of the occurrence of the particular event(s) upon which the contracts' maturing depends. Thus, the complete set preferably corresponds to the settlement value regardless of the outcome of the individual contracts or whether a particular contract is deemed to win. Furthermore, because at least the settlement value is preferably guaranteed independent of the occurrence of the event(s) upon which maturation of the contracts depends, the settlement value is preferably guaranteed even in the event that none of the contracts in the complete set is deemed to be a winner. This settlement value is determined and, except for the constant time value of money described below, can be considered to be constant. Thus, the complete set of contracts can be considered to be equivalent to a constant total sum (CTS) known as the settlement value. The settlement value can be determined in a variety of ways, typically based upon the price level of the underlying variable that characterizes the possible outcome(s) of the contracts in the complete set at the time the complete set is defined. Thus, the market conditions are preferably used in determining the settlement value. In one embodiment, the settlement value is related to the tick value of the underlying variable. For example, if the complete set of contracts relates to the price of a commodity, such as gold, the price level is preferably based upon the price of gold and, preferably, the tick value of the gold. In a preferred embodiment, the settlement value may be adjusted to account for an interest rate effect, and ensure that the time value of the settlement value is constant. Stated differently, an adjustment in present value may be made to ensure that the value of the settlement value remains constant over time. Consequently, where the settlement value is in money, such as money paid by buyer(s) in transaction(s) occurring in a typical stock exchange that is non-interest-bearing to the buyer(s) concerned, the settlement value is adjusted. Note, however, that another instrument having a value that automatically adjusts for the interest rate, such as money paid by buyers in transactions occurred in a typical futures exchange that is interest-bearing to buyers concerned, need not have the settlement value adjusted. In a preferred embodiment, the settlement value is adjusted based upon the initial settlement value determined at the time the complete set is defined. This initial settlement value is realized at a predetermined time, typically when the contract(s) mature due to the occurrence of the corresponding event(s). The settlement value is determined based upon the initial settlement value, the time between the exchange of the complete set and the predetermined time at which the initial settlement value would be realized, and the interest rate (which might vary) over that time period. In other words, the settlement value at a particular time can be considered to be the initial settlement value discounted to the particular time. In such a case, monies are preferably deposited in an interest bearing account in order to ensure the constant time value of the settlement value.

Each contract in the complete set preferably matures upon the same event(s) occurring. However, nothing prevents the contracts from maturing upon different events. The contracts in the complete set may relate to a particular range of a variable. In such a case, the winning contract(s) at the boundaries between ranges are determined when the complete set is defined. For example, each contract may be for a return if the price of a particular stock is within a range. In some complete sets, only one winner would exist at a boundary. In other complete sets, multiple contracts could be determined to be the winner at the boundary, with the winnings split in a particular fashion. In addition, in a preferred embodiment, the initial settlement value is for a time at which the contracts in the complete set mature. However, nothing prevents the at least one particular time and, therefore, the initial settlement value from corresponding to other times.

In the method and system described in the above-identified co-pending applications, the complete set preferably corresponds to the settlement value regardless of whether the particular event(s) occur for any of the plurality of contracts and regardless of the price for each of the contracts in the complete set. Preferably, market participant(s) are also allowed to obtain the complete set of contracts in exchange for the settlement value. For example market participants holding the complete set could actually exchange the complete set and the settlement value. Alternatively, the market participants could short the complete set (as well as contracts in the complete set). Consequently, the condition required to be met in order to obtain the settlement value is that the market participant(s) hold (or short) the complete set. Although a single market participant can hold the complete set, in a preferred embodiment multiple market participants who hold the complete set can form a group. As long as the group holds the complete set, the group can exchange the complete set for the settlement value. The settlement value could be provided in cash. However, in alternate embodiments, cash need not be used. For example, the settlement value can be paid in goods or a negotiable instrument particular to the exchange in which the transaction is made. Payment in such a negotiable instrument would secure greater loyalty of the market participant to the exchange because the settlement value could only be used in transactions in the exchange. In addition, profits for the exchange could be improved because of the increased number of transactions.

Using the method and system described in the above-identified co-pending applications, liquidity can be improved beyond the equilibrium established using conventional mechanisms. For example, equilibrium may be established in a conventional manner. As a result, all bids would be less than all offers for the contracts in a complete set. However, the sum of the bids for the contracts in the complete set may be greater than or equal to the settlement value. In such a case, a market participant or other entity may obtain the complete set in exchange for the settlement value. The contracts in the complete set could then be sold individually to each bidder to obtain a profit. Similarly, if the sum of the offers for the contracts in a complete set is less than or equal to the settlement value, then a market participant or other entity would use the offers to individually buy the contracts. The complete set could then be exchanged for the settlement value and a profit obtained. As a result, more transactions would take place. In addition, the bid-offer spread would be reduced. Liquidity is, therefore, improved.

The method and system described in the above-identified co-pending applications can also describe the use of a special purpose vehicle (SPV). The SPV described in the above-identified co-pending patent applications performs a variety of functions. The SPV can buy and sell one or more of the contracts in the complete set, preferably including the complete set itself. The SPV can make orders conditioned upon, among other factors, a particular trade being made. The SPV can also determine when it is profitable to individually buy and sell contracts, exchange the complete set for the settlement value, or exchange the settlement value for the complete set. For example, the SPV might determine that it is profitable to individually buy contracts in the complete set when the sum of the offer prices is less than or equal to the settlement value. The SPV might also determine that it is profitable to individually buy contracts in the complete set when the sum of the offer prices is slightly greater than the settlement value. The SPV might make this determination when the SPV is run by the exchange because the exchange receives payment on trades occurring. Furthermore, the SPV can interact with an entity such as an exchange window, that allows the complete set of contracts to be exchanged for the settlement value and vice versa. Note that, as described above with respect to the buying and selling of contracts, exchanging the complete set of contracts for the settlement value and vice versa could be considered to be shorting or longing the complete set.

Although the method and system described in the above-identified co-pending applications function well for their intended purpose, one of ordinary skill in the art recognize that the risks associated with multiple systems, described above, complicate matters.

The present invention provides a method and system for managing risk for a plurality of contracts offered for trading in plurality of systems. A complete set of contracts includes the plurality of contracts. The complete set guarantees at least an initial settlement value at at least one particular time. The complete set also corresponds to a settlement value, which is based upon the initial settlement value. In a preferred embodiment, the settlement value is also based on an interest rate effect, if necessary. A winning contract of the plurality of contracts pays a notional upon maturing. In addition, rate differentials, which result in hedging costs, exist between the systems. In one aspect, the method and system include determining whether a matching trade for the contract is possible in a second system of the plurality of systems. In this aspect, the method and system also include determining whether conducting a portion of the trade and a portion of the matching trade is profitable and, if so, performing the portion of the trade and the portion of the matching trade. Note that in the context of the application, trades could be profitable even when the revenue from the trades is negative, as described below. In another aspect, the method and system include determining whether it is profitable to individually sell the contract and a portion of the plurality of contracts. The portion of the plurality of contracts corresponding to at least one bid, if any. The at least one bid is in at least a second system corresponding to at least one rate differential between the first system and the at least the second system. The at least one rate differential results in the at least one hedging cost between the first system and the at least the second system. In this aspect, the method and system also include obtaining the complete set of contracts, if profitable, and individually selling the contract and the portion of the plurality of contracts, if profitable. In another aspect, the method and system include determining whether individually buying the contract at the particular price and a remaining portion of the plurality of contracts is profitable. At least one offer exists in at least a second system. Thus, at least one rate differential exists between the first system and the at least the second system. The rate differential results in the at least one hedging cost between the first system and the at least the second system. In this aspect, the method and system also include assembling the complete set by buying the contract and the remaining portion of the plurality of contracts, if required or profitable. In this aspect, the method and system also include exchanging the complete set for the settlement value, if profitable.

The present invention will be described in terms of a particular financial instruments and particular markets or exchanges. However, one of ordinary skill in the art will readily recognize that this method and system will operate effectively for other financial instruments and other market places. The present invention is also described in terms of particular components having certain features. However, one of ordinary skill in the art will readily recognize that the present invention is consistent with additional components and/or different or additional features. Furthermore, the present invention is described in the context of buying and selling. One of ordinary skill in the art will readily recognize that buying and selling can include shorting and/or longing. In addition, although the method and system are described separately in terms of exchange rates and credit risks, nothing prevents the use of the method and system in accordance with the present invention for a combination of exchange rates and credit risks and/or combination(s) of other analogous types of risks. Moreover, although certain examples are for the exchange rates only, the method and system operate effectively for credit risks, a combination of credit risks and exchange rates, and/or other risks. The present invention is also described in the context of holders financial instruments, such as the contracts, complete sets and hedging instruments, and transactions involving such financial instruments. However, one of ordinary skill in the art will recognize that financial instruments such as the complete set and contracts in the complete can be shorted. For example, a market participant may be considered to be a holder and might obtain the settlement value, initial settlement value, or other amount by shorting the corresponding financial instrument(s).

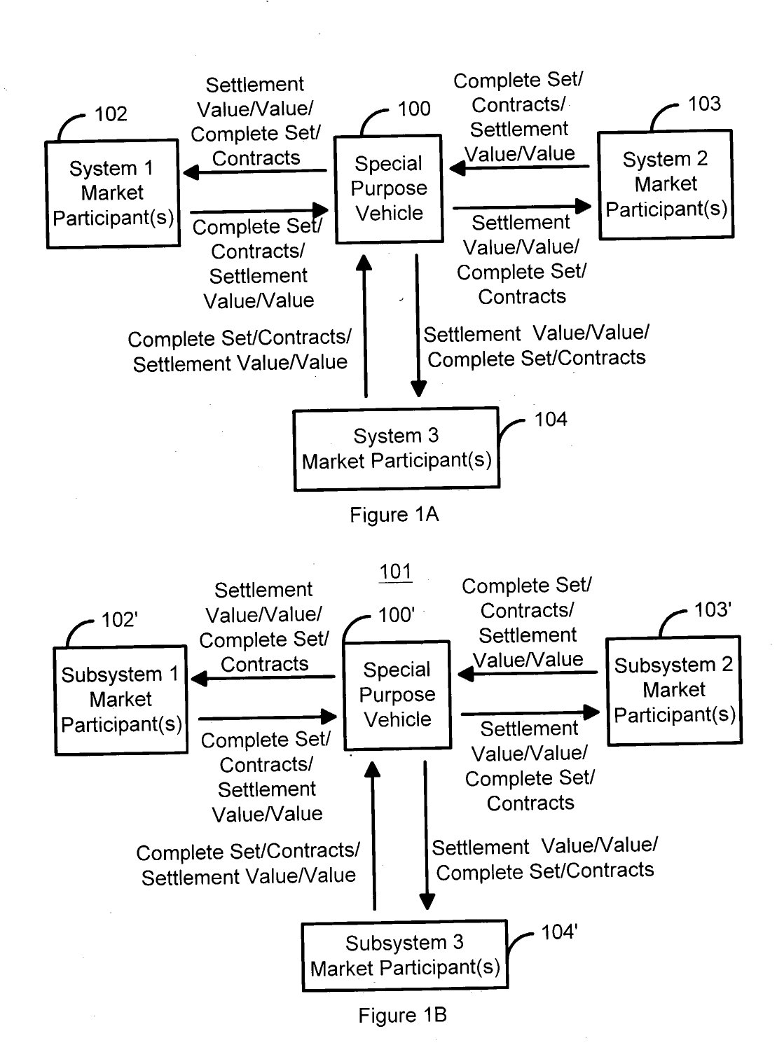

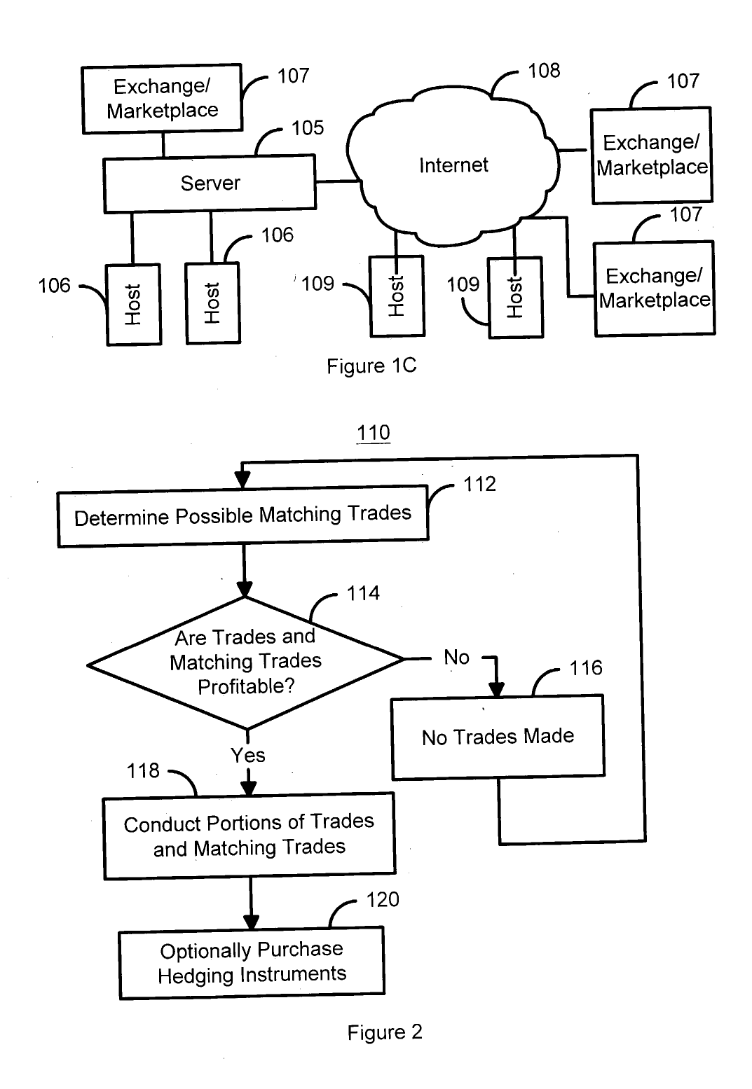

To more particularly illustrate the method and system in accordance with the present invention, refer now to FIG. 1A, depicting an SPV 100 in accordance with the present invention. The SPV 100 is used to manage risks associated with different systems, such as due to exchange rates and credit ratings. The SPV 100 can preferably function along with or as part of the SPVs described in the above-identified co-pending applications. In another embodiment, the SPV 100 can also function independently of and without the use of the SPVs described in the above-identified co-pending applications.

The SPV 100 interacts with market participants in systems 102, 103 and 104. Although three separate systems 102, 103, and 104 are depicted, nothing prevents the SPV 100 from interacting with another number of systems. As depicted in FIG. 1A, each of the systems 102, 103 and 104 is independent and, in general, uses a different type of currency. Each system 102, 103, and 104 could be considered an exchange, marketplace, or other entity for trading the contracts described in the above-identified co-pending applications. For example, the system 102 might be the NYSE, the system 103 might be the TSE, and the system 104 might be a stock exchange in Korea or Hong Kong. Although not specifically depicted, in addition to market participants, the SPV 100 may interact with other entities of the systems 102, 103 and 104. For example, the SPV might interact with exchange windows of the exchanges in systems 102, 103 and 104. As described above, an exchange window is considered to be an entity managed by an exchange through which the settlement value and complete set of contracts can be exchanged for each other. Because the SPV 100 interacts with the systems 102, 103 and 104, the SPV 100 is subject to rate differentials. In the example above, the rate differentials to which the SPV 100 is subject are exchange rates between the dollar, yen, and won. Furthermore, the systems 102, 103, and 104 may also be subject to different credit risks, as described with respect to the subsystems 102′, 103′, and 104′ in FIG. 1B.

FIG. 1B is a diagram depicting another embodiment of a SPV 100′ in accordance with the present invention interacting with market participants in different subsystems. Each subsystem 102′, 103′, and 104′ could be considered an exchange, marketplace, or other entity for trading the contracts described in the above-identified co-pending applications. For example, the subsystems 102′, 103′, and 104′ could represent different exchanges in a country or different gambling establishments. The subsystems 102′, 103′, and 104′ are preferably all part of the same system 101. Thus, the SPV 100′ is also depicted as functioning within the system 101. Because the subsystems 102′, 103′, and 104′ are all parts of the system 101, the subsystems 102′, 103′, and 104′ all preferably share the same currency. Thus, there is preferably no exchange rate differential between the subsystems 102′, 103′, and 104′. Although the subsystems 102′, 103′, and 104′ share the same currency, each subsystem 102′, 103′, and 104′ may have a different credit rating. As a result, the ability of the subsystems 102′, 103′, and 104′ to honor the contracts issued by themselves to their contract holders and to repay any margins/deposit from market participants (when deemed appropriate) may differ. Stated differently, the subsystems 102′, 103′, and 104′ each have a different probability that the subsystem 102′, 103′ and 104′, respectively, will undergo a catastrophic event, such as bankruptcy, that renders trades in the subsystems 102′, 103′, and 104′, respectively, unable to enforce trades. Thus, there is a rate differential between the subsystems 102′, 103′, and 104′ to which the SPV 100′ is subject.

FIG. 1C is a block diagram of one embodiment of a system in accordance with the present invention. The system is used for implementing the SPV 100 and allows risk to be managed. The system includes a server 105 that implements at least a portion of the SPV and the methods 110, 130, 130′, 150, and 160, described below. The server 105 is coupled with the exchanges or marketplaces 107. Although depicted as either directly connected to the server 105, or connected through the Internet 108, the exchanges/marketplaces 107 could be all be connected in the same manner to the server 105 (e.g. all through the Internet 108) or each could be connected in a different manner. Similarly, the exchange/marketplaces could be connected in another manner not shown. The server 105 may also be coupled to hosts 106 through a network and, via the Internet 108, to hosts 109. The server 105 preferably monitors the exchanges/marketplaces 107 to obtain information related to the risk management described below. For example, the server 105 could obtain information about exchange rates, prices, the notional value for contracts, the settlement value for contracts, the interest rate, the quantities of contracts offered for trades, and/or other information. In addition, the server 105 can transmit information to the exchanges/marketplaces 107. Individual contracts and/or complete set(s) of contracts may thus be traded by the SPV 100 through the exchanges/marketplaces 107. Furthermore, the server 105 may transmit such information to the hosts 106 and/or 109. The hosts 106 and/or 109 may thus be used by market participants to obtain information about the complete set(s) of contracts and to buy and/or sell contracts in the complete set. In addition, one or more of the hosts 106 and/or 109 may be used by authorized individual(s) to configure and control the server 105. The exchanges/marketplaces 107 may correspond to the systems 102, 103, and 104 or the subsystems 102′, 103′ and 104′. Thus, the hosts 106 and 109 may be used by the market participants of the systems 102, 103, and 104 or the market participants of the subsystems 102′, 103′, and 104′.

FIG. 2 is a high level flow chart of one embodiment of a method 110 in accordance with the present invention for managing risks by matching transactions. The method 110 is preferably implemented by the SPV 100 and 100′ and/or by the server 105. The method 110 preferably operates on contracts within the complete set of contracts described above and in the above-identified co-pending patent applications. Consequently, the complete set of contracts can be exchanged for the settlement value regardless of whether any of the contracts actually matures. Thus, even if none of the contracts is deemed a winner, the complete set can be exchanged for the settlement value, at least for a particular amount of time. The winning contracts also guarantees a value, termed a notional, upon maturing. In one embodiment, the notional is equal to the initial settlement value (the settlement value prior to the interest rate being accounted for). In a preferred embodiment, the notional is equal to the settlement value. For clarity, the method 110 is described in the context of the SPV 100 and the systems 102, 103 and 104, depicted in FIG. 1A. However, the method 110 is fully applicable to the systems such as those described in FIGS. 1B and 1C.

Referring to FIGS. 1A and 2, at the commencement of the method 110, one or more of the contracts in the complete set is offered for trade in one or more of the systems 102, 103, and 104. A quantity, which may be greater than or equal to one unit, of the contract is offered for trade. The trade being offered could be a bid to buy or an offer for sale. It is determined whether matching trades in other systems are possible, via step 112. In a preferred embodiment, step 112 includes determining whether appropriate quantities of the matching trades are possible. If the contract offered for trade is initially an offer for sale, then the matching trade would be a bid to buy the contract. If the trade is a bid to buy, then the matching trade is an offer to sell. For example, if the first system is the NYSE and the trade is an offer to sell a quantity of the USD contract at a particular price in dollars, then the matching trade might be a bid to buy another quantity of the Yen contract for yen on the TSE. The other systems have a rate differential, such as due to the exchange rate or a credit risk, associated with them. Because of the rate differential, there are hedging costs associated with the matching trades if the rate differential is to be managed. In a preferred embodiment, the hedging cost is based upon the notional or the settlement value. In the example above, the rate differential is the exchange rate. The hedging cost is, therefore, the cost of buying a yen/dollar option for the notional or settlement value.

It is determined whether conducting one or more of the matching trades, or a portion of the matching trades will be profitable, via step 114. As used herein, trades can be profitable when the revenue gained from the trades is negative. For example, some positive profit may be believed to be achievable in the long term even when the matching trade(s) have a negative profit. Similarly, the organizer of the SPV 100 might obtain revenue from trades being made. Thus, the revenue from the matching trade(s) plus the revenue from trades being made might be positive. In general, as used herein trade(s) are considered to profitable if the profit (e.g. revenue minus cost from the trade(s)) is not less than a particular number that can be negative. In a preferred embodiment, step 114 determines whether a profit from making a portion of the trade and a portion of the matching trade(s) is greater than or equal to the hedging cost. In such a case, the profit would be greater than or equal to zero. However, because the SPV 100 may be run by an exchange that makes profits on any transaction, in an alternate embodiment step 114 determines whether the profit is greater than or equal to the hedging cost minus a particular amount. In a preferred embodiment, the trade and the matching trade(s) have corresponding quantities. For example, if the trade is a bid for two contracts in a first system, the matching trade(s) would be for sufficient contracts in other system(s) to fill the two contracts in the first system. However, in an alternate embodiment only a portion of the trade and/or only a portion of matching trade may be conducted. In other words, less than the quantity in the trade and/or less than the quantity of contracts in the matching trade may be traded. Only portions of transactions (less than the full quantity) may be carried out because it may take time to wait for sufficient bids and/or offers to occur to actually perform the transactions. Thus, in some instances, less than the full quantities of the trade and/or the matching trade may be utilized.

The hedging cost is also preferably determined in step 114. The hedging cost is based upon the risk to which the SPV 100 is exposed. In one embodiment, the hedging cost is based on the notional, which is the payment made on the winning contract. In another embodiment, the hedging cost is based upon the settlement value, which is what the SPV would pay to receive the complete set (including the contract being traded). In a preferred embodiment, the constant total sum and/or settlement value of a complete set limits the maximum amount of risk per contract and/or per complete set for trading across systems. Therefore, maximum hedging cost required can be determined and matching trades made possible with the risk under control.

If it is determined that making the portion of the trade the portion of the matching trade is not profitable, then the SPV 100 simply waits, via step 116. However, if it is determined that conducting the portion of the trade and the portion of the matching trade is profitable, then these trades are conducted, via step 118. In a preferred embodiment, the SPV 100 is allowed to lock in trades substantially simultaneously. Thus, the risk that the SPV would make the trade and not be able to make the matching trade because another market participant had done so, or vice versa, would be reduced. The hedging instrument is also optionally bought, via step 120.

Thus, the SPV 100 can make profitable trades based upon rate differentials, such as credit ratings or exchange rates. The profit of the exchange or other entity controlling the SPV 100 can, therefore, be increased. Furthermore, without the SPV 100 performing the portion of the trade and matching trade(s), these transactions may not be conducted. Consequently, using the method 110, liquidity can be improved.

For example, suppose that a complete set of contracts includes contracts C1, C2 and C3. Upon maturity, assume that at most one of C1, C2 and C3 will pay one hundred units of respective currency—USD, yen or won depending on the system the contracts belong to. Furthermore, assume that the settlement value is also one hundred units of respective currency. In a first system, the NYSE, suppose that a bid to buy the contract C1 for US$40 exists. Assume that two offers to sell the contract C1 at thirty-eight (38) yen exist on the TSE. The first offer is for one hundred (100) units of C1 and the second offer is for twenty-five (25) units of C1. In addition, a bid to buy the contract C1 at twenty-seven (27) won on a third system, a Korean exchange, exists. Also assume that the exchange rates are one hundred and twenty-five (125) yen per dollar and one thousand two hundred thirty (1230) won per dollar at a certain time. The SPV 100 could use the offers on the TSE or the bid in either the NYSE or Korea in order to perform the method 110. Suppose that the SPV 100 uses the bid on the NYSE. The SPV would locate the offers on the TSE as possible matches in step 112. The amount of profit, P, is given by:

P=Q_{A}*P_{A}−Q_{B}*P_{B}/R

where

P=Profit

Q_{A}=Quantity on System A

P_{A}=Price of Contract on System A

Q_{B}=Quantity on System B

P_{B}=Price of Contract on System B

R=Exchange rate between System A and System B

In addition, note that the quantity contracts bought accounts for the exchange rate. For exchange rates having a decimal place (e.g. 125.47), either the quantity is large enough (e.g. 100 to 12,547), or the nearest integer is used for the quantity (and strike of option used as a hedging instrument follows accordingly). Moreover, note that for examples described, the contract holders assume that no interest income is received for the money “spent” on buying contracts. For a system that pays interest to money put in, forward exchange rate is preferably considered and forward foreign exchange transaction is preferably performed. In addition, the interest cost for the hedging cost is preferably considered because such a cost would generally be paid upfront. Also, for example described, settlement value is assumed as 100 of the currency unit concerned for easy reference. Thus, the SPV 100 would use both of the offers on the TSE to determine the profit in step 114. If a different situation exists, for example offers for greater than one hundred twenty-five units of C1 existed on the TSE, then the SPV 100 would only make a portion of the matching trades to match the bid for a single C1 on the NYSE. Conversely, if the bids on the NYSE were for two contracts C1, then the SPV would not use all of the bids (would make only a portion of the trade). Based on the prices and exchange rates, in the example above, the SPV 100 would determine the profit to be $2. Such an amount is determined by the expected income from short-selling one lot of USD contracts of C1 at a price of US$40, minus the money needed to buy one hundred twenty-five lots of Yen contracts at thirty-eight yen each. The price of the Yen contracts translates to US$38 (125×38/125). The income is thus given by US$40 minus US$38, which equates to US$2. However, the SPV 100 would also determine the hedging cost. The SPV 100 could use either to determine the hedging cost. Because C1 is part of a complete set, the notional (what the SPV 100 would have to pay out) or the settlement value (the cost of buying a complete set including C1) could be used to determine the hedging cost. The notional, the amount paid to a holder of C1 if C1 wins, is US$100. In addition, the settlement value—what the SPV 100 would have to pay to obtain a complete set (including C1) is US$100. In either case, the hedging cost would be the cost of a dollar call/yen put at a strike price of one hundred and twenty-five yen for an amount of one hundred US dollars (such US$100 is the amount of the hedging instrument to buy). Thus, the holder of the hedging instrument would have the right, but not obligation to receive one hundred US dollars for surrendering yen at the exchange rate of one hundred and twenty-five yen per dollar. In step 114, the SPV 100 would preferably determine whether this hedging cost is less than or equal to $2. If so, the SPV 100 would make the trade and the matching trade in step 118. In step 120, the SPV would also buy the dollar call/yen put described above.

Moreover, profits from more than one matching trades can be combined to help pay up for the hedging cost. Suppose that for the above example the hedging instrument costs $3, which is more than the $2 profit from the matching trade on C1. If the system can find a matching trade on contracts from the same set other than C1, say, C2 with a profit of $1 or more, the combined profit will be sufficient to meet the hedging cost. The two matching trades on C1 and C2 can be done together with only one hedging instrument only as needed. This is because the maximum risk of C1 and C2 combined, following the nature of a contract set, will be equal to or less than settlement value.

Note that the hedging instrument will have a definite expiry date and has a cost to extend beyond that date. Therefore, the contract set preferably has a well-defined expected maturity date, on or before which the outcome and payout to contracts would be determined. The terms and conditions of contracts preferably also allow for settlement in case of delay (termination settlement). In general, the outcome is not decided yet due to delay and the initial settlement value will be distributed to contracts in a pre-determined way, following the rule of constant total sum to the complete set. Therefore, contract holders know beforehand of such termination settlement arrangement and SPV 100 need not bear the unknown cost of involuntarily extending the life of hedging instrument to carry the matching trades.

Similarly, suppose a bid for C1 at $40 exists on one system 102′ and an offer to sell C1 at $38 exists on a second system 103′, the SPV 100′ would calculate a profit of $2 upon making the trade (both long and short C1 of different systems) in step 114. If C1 pays out, upon maturity, the SPV 100 expects to receive $100 from the seller on the second system 103′ and pays $100 to the buyer on the first system 102′. Consequently, the SPV 100′ is at risk of the seller of C1 (or, actually the system 103′) not honoring the contract. The SPV 100′ can account for this risk through a hedging instrument having a hedging cost. In this example, the hedging instrument might be a letter of credit, credit derivatives or other guarantee. The hedging instrument would be based upon the notional or the settlement value as described above. The SPV 100′ would also determine the cost of the hedging instrument in step 114 and whether the cost is less than or equal to the $2 profit. The SPV 100′ would carry out the transactions on the first system 102′ and the second system 103′ in step 118 and buy the hedging instrument in step 120.

Thus, the SPV 100 can determine whether a profit is to be made by transactions between systems having a rate differential. The SPV 100 can perform the transactions when profitable. Thus, the profit of the entity utilizing the SPV 100 can be increased. In addition, because trades that might not otherwise be made are conducted by the SPV 100, liquidity is improved.

Furthermore, hedging costs can be reduced for other contracts in the complete set using the method 110. Once step 120 of the method 110 is performed, the SPV 100 has a hedging instrument for a risk differential between a first system and a second system, such as the NYSE and the TSE in the above example. Because the contracts are all part of a complete set, the hedging instrument may be “used” again to buy any of the remaining the contracts in the same set (i.e. except C1). Thus, once the hedging instrument has been bought for one contract in the complete set, the hedging instrument can also be used for any other contract in the complete set. The complete set, therefore, allows the hedging cost to be shared between contracts in the complete set. In the exchange rate example above, if a bid for C2 and/or C3 on the NYSE appears and the exchange rate is unchanged, the SPV 100 can obtain matching trades on the TSE without buying another hedging instrument. If the exchange rate has changed, then the SVP 100 need only account for the difference in the exchange rates since the buy of the hedging instrument.

If no further hedging instrument is bought, matching trades may be done with quantities of contracts following the ratio implied by option's strike (rather than the new or current exchange rate). The matching trade is by itself a break-even or better trade as measured by P>=0 for P=QA*PA−QB*PB/R, R being the current exchange rate, and QA and QB follow the ratio implied by the FX option's strike. Thus, step 114, determining whether making trades and matching trades is profitable is simplified by the reduced (or zero) hedging cost. If contracts corresponding to more than one complete set are held by the SPV 100, then more than one hedging instrument is bought. For example, if a complete set is two Cₐ, one C_{b} and three C_{c} (Cₐ, C_{b} and C_{c} are in different currency systems), then more than one hedging instrument is bought if the SPV 100 holds more than two Cₐ, more than one C_{b}, and/or more than three C_{c}. Consequently, in addition to accounting for the rate differential, the method 110 allows for potential sharing and therefore reduction in hedging costs.

Furthermore, hedging instruments can be combined to provide new trading opportunities. For example, a matching trade is done on long yen contract/short USD contract on C1. Another matching trade is done on long USD contract/short won contract on C2. In fact, by sharing two hedging instruments arisen from the two matching trades, a matching trade may be done on C3 for long yen contract/short won contract without additional hedging instrument needed. It is because the first hedging instrument will allow for matching trade of long yen contract/short USD contract on C2 or C3, which the second will allow for long USD contract/short won contract on C1 and C3. Combining the two for common contract C3 will lead to possible trade on long yen contract/short won contract for C3.

Furthermore, hedging instruments can be partially or completely recycled. The SPV 100 may choose to unwind transactions having a risk due to a rate differential. For example, SPV 100 may wait for a particular market situation to unwind matching trades (opposite to matching trade). If after a matching trade the SPV 100 is long one hundred twenty five units of yen contracts of C1 and short one unit of USD contracts of C1, the SPV 100 can sell the long yen contract and short-cover/buy the short USD contract simultaneously if and when such trades are profitable. Such unwinding will not require hedging instrument and in fact would release the hedging instrument after unwinding. For further example, the hedging instrument has a market value, and such market value will help to unwind the matching trade. Suppose the hedging instrument, which is initially bought at US$2, is now worth US$3 due to changes in market conditions (e.g. changes in the exchange rate). If the SPV 100 checks the market and finds that the long yen contract can be sold and the short USD contract can be short-covered/bought simultaneously at a loss of US$3 or less, the SPV 100 can proceed with the unwinding as the loss can be subsidized by the income from selling out the hedging instrument at US$3. In another example, the SPV 100 may exchange a complete set for the settlement value or vice versa. For example, suppose the SPV 100 is now short a complete set of USD contracts and long a complete set of Yen contracts. The SPV 100 will be short USD$100 of cash and long 12,500 yen after converting the contract positions into settlement values. If the current exchange rate of USD/Yen is above 125 (which is the strike of the option bought as a hedging instrument and the exchange rate when the initial round of matching trade(s) was done), the long yen cash would be insufficient to offset for the short USD cash (this explains why hedging instrument is needed for the matching trades). The hedging instrument, the option, could then be sold to pay for the difference (the value of option is high enough to pay for it). However, if exchange rate moves favorably or stays such that current exchange rate of USD/Yen being one hundred and twenty-five or lower, the short US100 cash/long 12,500 yen position can be unwound without changing the option position. An extra profit maybe realized from unwinding the short US100 cash/long 12,500 yen position. Taking an extreme example, if USD/Yen exchange rate has moved from one hundred twenty-five to one hundred, the long yen cash of 12,500 yen will be exchanged into USD125. After repaying the short USD cash of USD100, there will be a positive balance of USD25 as extra profit. The SPV 100 could then still hold the hedging instrument for the risk differential between a first system and a second system. The SPV 100 may then find other trades in the first system and matching trades in the second system using the method 110. Because the SPV 100 still holds the hedging instrument, step 114 would be simplified in that the hedging cost would be zero (or reduced). Consequently, the SPV 100 could obtain additional profit using the method 110 and recycling the hedging instrument. Recycling may also mean simply selling the hedging instrument for cash. Such hedging instruments have a non-negative value as the hedging instruments provide a right but not an obligation to the holder. In the example above, suppose that the SPV 100 assembles one hundred and twenty five units of the complete set of contracts in the TSE, then exchanges the complete sets for the settlement amounts (therefore resulting in long cash in yen currency). The SPV 100 also exchanges the settlement amount in dollars for the complete set in the NYSE (therefore resulting in short cash in USD currency). The SPV might choose to make these exchanges because it is profitable to do so. The SPV 100 has thus unwound any shorting and longing of contracts in the NYSE and TSE. Upon favorable conditions such as current level of USD/Yen exchange rate, the SPV 100 may still use the hedging instrument bought in step 120 when performing the method 110 again. Thus, step 114 of determining profitability may be changed because the hedging cost may be reduced or eliminated. Similarly, the step 120 of buying the hedging instrument might be omitted. Thus, the hedging instrument is potentially recycled, either partially or completely.

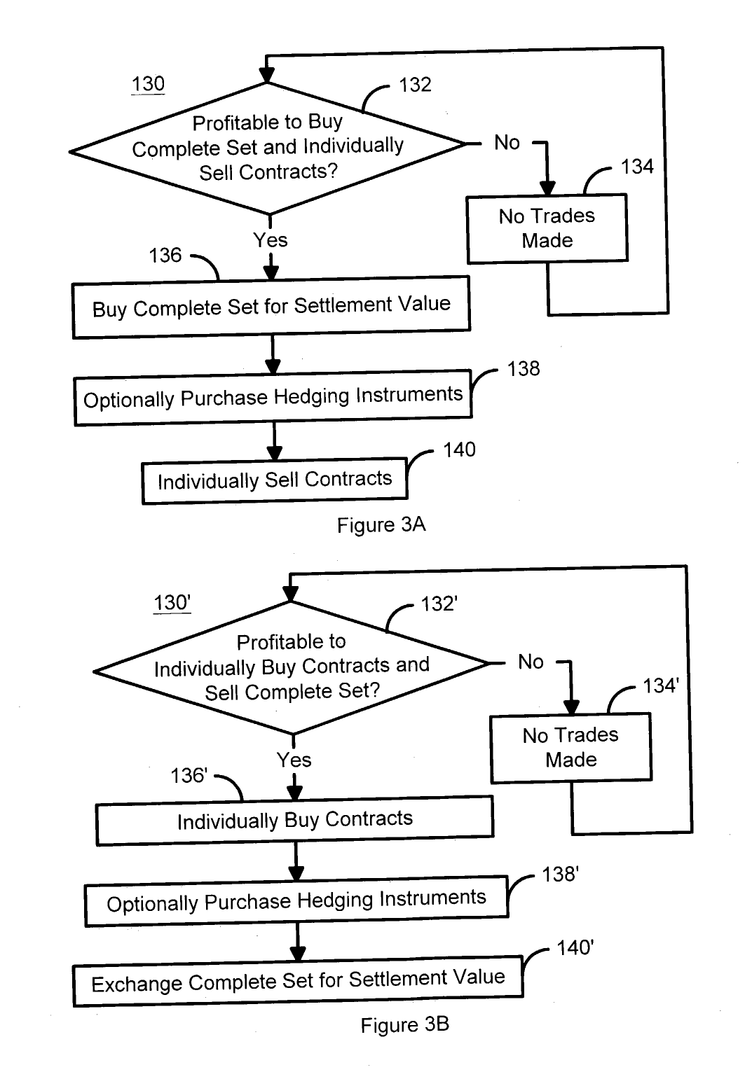

FIG. 3A is a more-detailed flow chart depicting one embodiment of a method 130 in accordance with the present invention for using the SPV 100 to manage risks by individually selling contracts in a complete set using different systems having rate differentials. The method 130 is preferably implemented by the SPV 100, 100′ and/or by the server 105. The method 130 preferably operates on contracts within the complete set of contracts described above and in the above-identified co-pending patent applications. In a preferred embodiment, the complete set of contracts can be exchanged for at least the settlement value regardless of whether any of the contracts actually matures. Thus, even if none of the contracts is deemed a winner, the complete set can be exchanged for at least the settlement value, at least for a particular amount of time. In a preferred embodiment, the complete set is exchangeable for settlement value itself. The winning contracts also guarantees a value, termed a notional, upon maturing. In one embodiment, the notional is equal to the initial settlement value (the settlement value prior to the interest rate being accounted for). In a preferred embodiment, the notional is equal to the settlement value. For clarity, the method 130 is described in the context of the SPV 100 and the systems 102, 103 and 104, depicted in FIG. 1A. However, the method 130 is fully applicable to the systems, such as those described in FIGS. 1B and 1C.

Referring to FIGS. 1A and 3A, the SPV 100 determines whether it is profitable to individually sell the contracts in a complete set in one or more systems, via step 132. Thus, step 132 preferably includes reviewing the bids in different systems, determining the hedging costs for the systems, and determining the current settlement value in the systems. In a preferred embodiment, step 132 determines whether the sum of the bid prices for the contract(s) in the complete set minus the hedging cost (if any) is greater than or equal to the settlement value. However, in an alternate embodiment, the sum of the bid prices plus the hedging cost may be less than the settlement value. If it is determined that it is not profitable, then the SPV 100 does not conduct the transactions, via step 134.

If it is profitable, then the SPV 100 exchanges the settlement value for the complete set in a selected system, via step 136. In a preferred embodiment, step 136 is performed by the SPV using the exchange window of a particular system 102, 103, or 104. Thus, the SPV 100 has obtained the contracts. The SPV 100 also optionally buys hedging instrument(s), via step 138. Because the complete set can be obtained for the settlement value, the hedging costs of the hedging instruments are based on the settlement value and the rate differentials between systems. Furthermore, in a similar manner to what is described above, the hedging costs may be recycled. Thus, the hedging instrument need not be bought more than once for a single set of contracts. Multiple hedging instruments are reported for multiple complete sets. The SPV can then individually sell the contracts to fulfill bids in the system(s), via step 140.

For example, suppose the contracts C1, C2, and C3 described above have the following bids: thirty dollars for one unit of C1 on the NYSE, one hundred twenty five units of C2 at fifty yen each on the TSE, and one thousand two hundred thirty units of C3 at twenty-seven won on a Korean exchange. The money received from individually selling contracts in the complete set is given by the sum over the systems of the quantity on each system multiplied by the price at each system divided by the exchange rate between a first system and each system. In the example above, assume that the SPV 100 works in dollars, the “base currency”. In theory, any base currency can be chosen. In practice, it is preferable to choose a base currency from the systems involved (e.g. either USD, yen or won). Otherwise three instead of two hedging instruments would be bought, which almost certainly will increase the total hedging cost. The profit before hedging cost is the money received minus the settlement value ($100). In the example above, the profit before hedging is $7. This is calculated based on the money received from selling the contracts (US$30×1, plus 50 yen×125, plus 37 won×1,230), which sum up to US$107 using exchange rates of USD/yen of 125 and USD/won of 1,230. The money received, US$107, minus the settlement value of US$100 (used for subscribing a complete set of USD contracts) equal seven dollars ($107−$100). Step 132 may determine that it is profitable for the SPV 100 to individually sell C1, C2 and C3 if the hedging cost is less than $7. In this case, two hedging instruments are bought because two systems other than the base currency system (TSE and Korea) are used. Two hedging instruments are used because the above trades are now reduced to two pairs of matching trades. SPV 100 will have contract positions of: short one of C1 USD contract, short one hundred twenty-five of C2 Yen contracts, and short 1,230 of C3 Won contracts after step 140. By taking $100 out of $107 to subscribe for a complete set of USD contracts in step 136, the new accumulated contract positions become: zero net position of C1 USD contract, short one hundred twenty-five Yen versus long one USD contract of C2, and short 1,230 won versus long one USD contract of C3. The last two contract positions, on C2 and C3, corresponding to matching trades requiring two hedging instruments as described in method 110.

Thus, the SPV 100 can determine whether a profit is to be made by individually selling contracts on systems having rate differentials. The SPV 100 can perform the transactions when profitable. Thus, the profit of the entity utilizing the SPV 100 can be increased. In addition, because trades that might not otherwise be made are conducted by the SPV 100, liquidity is improved. Furthermore, as discussed above, hedging costs may be recycled.

FIG. 3B is a more-detailed flow chart depicting one embodiment of a method 130′ in accordance with the present invention for using the SPV 100 to manage risks by individually buying contracts in a complete set using different systems having rate differentials. The method 130′ is preferably implemented by the SPV 100, 100′ and/or by the server 105. The method 130′ preferably operates on contracts within the complete set of contracts described above and in the above-identified co-pending patent applications. Consequently, the complete set of contracts can be exchanged for at least the settlement value regardless of whether any of the contracts actually matures. Thus, even if none of the contracts is deemed a winner, the complete set can be exchanged for at least the settlement value, at least for a particular amount of time. The winning contracts also guarantees a value, termed a notional, upon maturing. In one embodiment, the notional is equal to the initial settlement value (the settlement value prior to the interest rate being accounted for). In a preferred embodiment, the notional is equal to the settlement value. For clarity, the method 130′ is described in the context of the SPV 100 and the systems 102, 103 and 104, depicted in FIG. 1A. However, the method 130′ is fully applicable to the systems, such as those described in FIGS. 1B and 1C.

Referring to FIGS. 1A and 3B, the SPV 100 determines whether it is profitable to individually buy the contracts in a complete set in one or more systems and exchange a complete set for the settlement value, via step 132′. Thus, step 132′ preferably includes reviewing the offers in different systems, determining the hedging costs for the systems, and determining the current settlement value in the systems. In a preferred embodiment, step 132′ determines whether the sum of the offer prices for the contract(s) in the complete set plus the hedging cost (if any) is less than or equal to the settlement value. However, in an alternate embodiment, the sum of the offer prices plus the hedging cost may be greater than the settlement value, for example if the SPV 100 is run by an exchange. If it is determined that it is not profitable, then the SPV 100 does not conduct the transactions, via step 134′.

If it is profitable, then the SPV 100 assembles the complete set by individually buying the appropriate amounts of the contracts in one or more selected systems, via step 136′. Thus, the SPV 100 has obtained the contracts. The SPV 100 also optionally buys hedging instrument(s), via step 138′. Because the complete set can be obtained for the settlement value, the hedging costs of the hedging instruments are based on the settlement value and the rate differentials between systems. Furthermore, in a similar manner to what is described above, the hedging costs may be recycled. Thus, the hedging instrument need not be bought more than once for a single set of contracts. Multiple hedging instruments are reported for multiple complete sets. The SPV can then individually buy the contracts to fulfill offers in the system(s), via step 140′. In a preferred embodiment, step 140′ is performed by the SPV using the exchange window of a particular system 102, 103, or 104.

For example, suppose the contracts C1, C2, and C3 described above have the following offers: US$20 for one unit of C1 on the NYSE, one hundred twenty five units of C2 at fifty yen each on the TSE, and one thousand two hundred thirty units of C3 at twenty-seven won on a Korean exchange. The money spent by individually buying is given by the sum over the systems of the quantity on each system multiplied by the price at each system divided by the exchange rate between each system and a first system. In the example above, assume that the SPV 100 works in dollars. The profit before hedging is the settlement value ($100) minus the money spent to buy the contracts. In the example above, the profit before hedging is $3. Step 132′ may determine that it is profitable for the SPV 100 to individually buy C1, C2 and C3 if the hedging cost is less than $3. In this case, two hedging instruments are bought because two systems (TSE and Korea) are used. Note that if the example above was for subsystems sharing a currency, for example for credit risks, the exchange rate need not be accounted for (or can be considered to be one).

Thus, the SPV 100 can determine whether a profit is to be made by individually buying contracts on systems having rate differentials. The SPV 100 can perform the transactions when profitable. Thus, the profit of the entity utilizing the SPV 100 can be increased. In addition, because trades that might not otherwise be made are conducted by the SPV 100, liquidity is improved. Furthermore, as discussed above, hedging costs may be recycled.

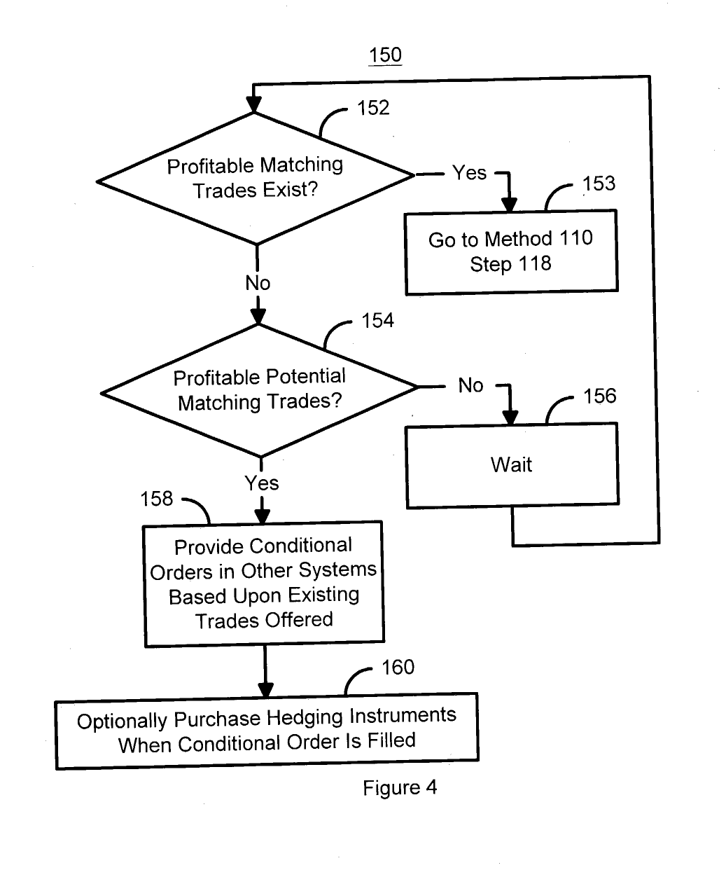

FIG. 4 is a flow chart depicting one embodiment of a method 150 in accordance with the present invention for managing risks by making conditional orders. The method 150 is preferably implemented by the SPV 100, 100′ and/or by the server 105. The method 150 preferably operates on contracts within the complete set of contracts described above and in the above-identified co-pending patent applications. Consequently, the complete set of contracts can be exchanged for at least the settlement value regardless of whether any of the contracts actually matures. Thus, even if none of the contracts is deemed a winner, the complete set can be exchanged for at least the settlement value, at least for a particular amount of time. The winning contracts also guarantees a value, termed a notional, upon maturing. In one embodiment, the notional is equal to the initial settlement value (the settlement value prior to the interest rate being accounted for). In a preferred embodiment, the notional is equal to the settlement value. For clarity, the method 150 is described in the context of the SPV 100 and the systems 102, 103 and 104, depicted in FIG. 1A. However, the method 110 is fully applicable to the systems such as those described in FIGS. 1B and 1C.

Referring to FIGS. 1A and 4 at the commencement of the method 150, one or more of the contracts in the complete set is offered for trade in one or more of the systems 102, 103, and 104. A quantity, which may be greater than or equal to one unit, of the contract is offered for trade. The trade being offered could be a bid to buy or an offer for sale. It is determined whether matching trades that are profitable in other systems are possible, via step 152. Step 152 is thus analogous to step 112 and 114 of the method 110. The other systems have a rate differential, described above. Because of the rate differential, there are hedging costs associated with the matching trades if the rate differential is to be managed. In a preferred embodiment, the hedging cost is based upon the notional or the settlement value. Note that step 152 requires both searching for possible matching trades and determining whether the matching trades are profitable. If there are matching trades, then the method 110 is returned to, via step 153.

If there are no matching trades or no matching trades that are profitable, then potential matching trades that may be profitable are determined, via step 154. In a preferred embodiment, step 154 determines potential matching trades based on the price of the trade and the hedging cost. The potential matching trades are theoretical, rather than existing; because no corresponding offers or bids exist. Also in a preferred embodiment, the potential matching trades are determined such that the profit from the potential matching trade is greater than or equal to the hedging cost. However, because the SPV 100 may be run by an exchange that makes profits on any transactions, in an alternate embodiment step 154 determines whether the profit is greater than or equal to the hedging cost minus a particular amount. In a preferred embodiment, the trade and the potential matching trade(s) have corresponding quantities. For example, if the trade is a bid for two contracts in a first system, the potential matching trade(s) would be for sufficient contracts in other system(s) to fill the two contracts in the first system. However, in an alternate embodiment only a portion of the trade and/or only a portion of potential matching trade may be used. In other words, less than the quantity in the trade and/or less than the quantity of contracts in the matching trade may be traded. This may occur because it may be undesirable to take the time for such bids and/or offers to be accepted.

In order to determine the profitable potential matching trades, the hedging cost is preferably determined in step 154. The hedging cost is based upon the risk to which the SPV 100 is exposed. In one embodiment, the hedging cost is based on the notional, which is the payment made on the winning contract. In another embodiment, the hedging cost is based upon the settlement value, which is the least the SPV would pay to receive the complete set (including the contract being traded). Thus, step 154 preferably determines the conditions of the potential matching trade. For example, step 154 determines the system(s), quantities, rate differentials (which may be the current rate differentials) and hedging cost for potential matching trades that might be profitable.

If no potential matching trades that are profitable can be determined, then the SPV 100 simply waits, via step 156. However, if potential matching trades that are profitable are calculated in step 154, then the SPV 100 makes conditional order(s) corresponding to these potential matching trades, via step 158. The conditional orders made in step 158 are for one or more of the potential matching trades that the SPV 100 ascertained in step 154. Each conditional order made in step 158 has corresponding conditions. One condition is that the trade upon which the conditional orders are based is made. Another condition might be that transactions for any conflicting conditional orders not be completed. More than one conditional order may be provided based upon the same existing trades offered. The SPV 100 makes the potential matching trade and the trade for any conditional orders that are accepted. If the conditional order is accepted and the condition(s) are fulfilled, then the SPV 100 would make the trade and the transaction for the conditional order be made with the hedging instrument optionally bought, via step 160.

For example, suppose C1, C2 and C3 are a complete set and that a bid for C1 at a price of US$40 exists on the NYSE. This is the same trade described in the example for the method 110. However, no bid exists on the TSE or in Korea. Also assume that the exchange rate is one hundred twenty-five yen per dollar and one thousand two hundred thirty won per dollar. Assume that the settlement value and notional are one hundred dollars. Using the method 150, the SPV 100 could calculate conditional orders on the TSE or in Korea. Because the settlement value or notional and exchange rates are known, the hedging costs can be calculated. Once the hedging costs are calculated, a profitable transaction (e.g. profit minus hedging cost greater than zero) can be determined. For example, suppose that a dollar call/yen put at a strike of one hundred and twenty-five yen per dollar and a dollar call/won put at a strike of one thousand two hundred thirty won per dollar for the settlement value or notional cost one dollar and two dollars respectively. The SPV 100 might determine in step 154 that a potential matching trade of an offer for one hundred twenty-five units of C1 at a price of forty-one yen per unit would be profitable. Similarly, the SPV 100 might determine in step 154 that a potential matching trade of an offer for one thousand two hundred thirty units of C1 at a price of forty-two won per unit would be profitable. Notice that the quantity of one hundred twenty five yen contracts is “all-or-nothing”. It is expected to be done for the whole one hundred twenty five contracts, rather than any number smaller. The same is true for 1,230 of won contracts. In step 156 the SPV 100 would make one or more conditional orders using the potential matching trades determined. Thus, the SPV 100 might make two conditional orders, one in the TSE and one in Korea, using the potential matching trades described above. The conditions attached to each conditional order would be that the bid of C1 at $40 is accepted on the NYSE and that none of the other conditional orders are accepted.

Thus, using the method 150, the SPV 100 can potentially obtain a profit. In addition, because of the use of conditional orders, more offers and/or bids (of conditional nature) can be provided where none or no profitable ones existed before. More transactions may thus be performed, more executable bid and offer information available, and the bid-offer spread may be reduced. Consequently, liquidity can be improved.

The methods 110, 130, 130′, and 150 can be used by the SPV 100 to improve profitability and improve liquidity. Profit can be further improved by adjusting the hedging costs, such as strike prices, based upon the changing rate differentials. In particular, the SPV 100 may do more to explore other rate differentials to determine at which rate transactions should take place to improve profit.

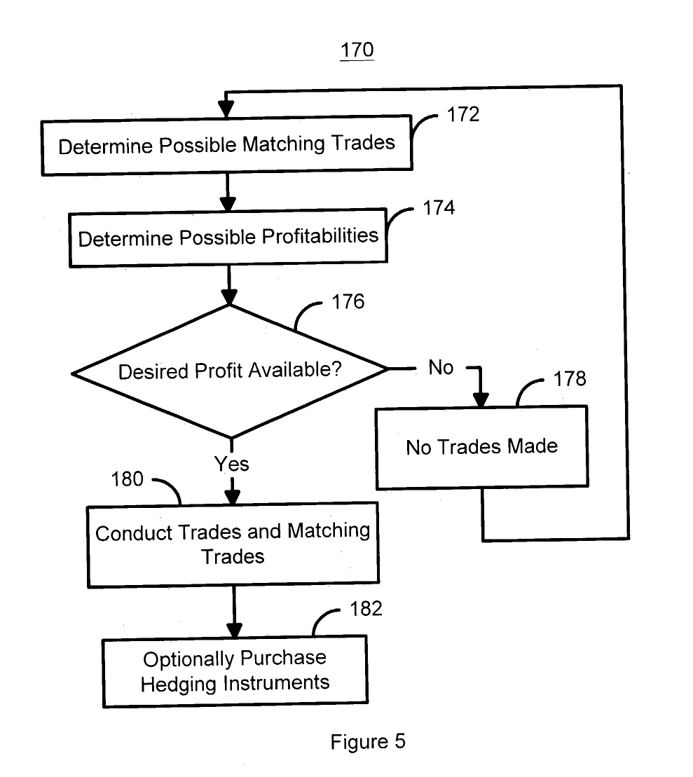

FIG. 5, for example, is a flow chart depicting one embodiment of method 170 in accordance with the present invention for managing risks based on adjustments in the risks between systems. The method 170 finds particular utility for more volatile systems where the rate differentials, such as the exchange rate or credit ratings, are changing rapidly and/or greatly. However, nothing prevents the use of the method 170 in other instances.

The method 170 is preferably implemented by the SPV 100, 100′ and/or by the server 105. The method 170 preferably operates on contracts within the complete set of contracts described above and in the above-identified co-pending patent applications. Consequently, the complete set of contracts can be exchanged for at least the settlement value regardless of whether any of the contracts actually matures. Thus, even if none of the contracts is deemed a winner, the complete set can be exchanged for at least the settlement value, at least for a particular amount of time. The winning contracts also guarantees a value, termed a notional, upon maturing. In one embodiment, the notional is equal to the initial settlement value (the settlement value prior to the interest rate being accounted for). In a preferred embodiment, the notional is equal to the settlement value. For clarity, the method 170 is described in the context of the SPV 100 and the systems 102, 103 and 104, depicted in FIG. 1A. However, the method 170 is fully applicable to the systems such as those described in FIGS. 1B and 1C.

Referring to FIGS. 1A and 5 at the commencement of the method 110, one or more of the contracts in the complete set is offered for trade in one or more of the systems 102, 103, and 104. A quantity, which may be greater than or equal to one unit, of the contract is offered for trade. The trade being offered could be a bid to buy or an offer for sale. It is determined whether matching trades in other systems are possible, via step 172. Step 172 is analogous to step 112 of the method 110.

Possible profitabilities of the matching trades are determined, via step 174. Step 174 preferably uses the matching trades located in step 172, but accounts for changes in the rate differentials. As discussed above, a trade can be profitable even if the profit obtained is negative. In another embodiment, different fictitious trades could also be used to account for other scenarios that might arise as the market changes. Step 174 includes determining the hedging costs for the different rate differentials based upon the settlement values or notionals.

It is determined whether the current profit made by conducting a portion of the trade and a portion of the matching trade at the existing rate differentials with the existing hedging costs is desirable, via step 176. In one embodiment, step 176 merely determines if the profit exceeds the hedging costs. In another embodiment, step 176 determines whether the profit is at least a particular amount above or below the hedging cost. This amount is preferably determined based upon which direction it is believed the rate differential will move. If the current profit is not desirable, then the SPV 100 waits in step 178, then returns to step 174. When the current profit is the desired profit, then the portion of the trades and the portion of the matching trades are conducted, via step 180. In addition, the hedging instruments are optionally bought in step 182. Upon subsequent iterations, the hedging instrument may not need to be bought, or fewer hedging instrument may be bought because of the possibility of sharing and recycling of hedging instruments.

Thus, the SPV 100 can make profitable trades based upon changing rate differentials, such as credit ratings or exchange rates. The profit of the exchange or other entity controlling the SPV 100 can, therefore, be increased. Furthermore, without the SPV 100 performing the portion of the trade and matching trade(s), these transactions may not be conducted. Consequently, using the method 170, liquidity can be improved.

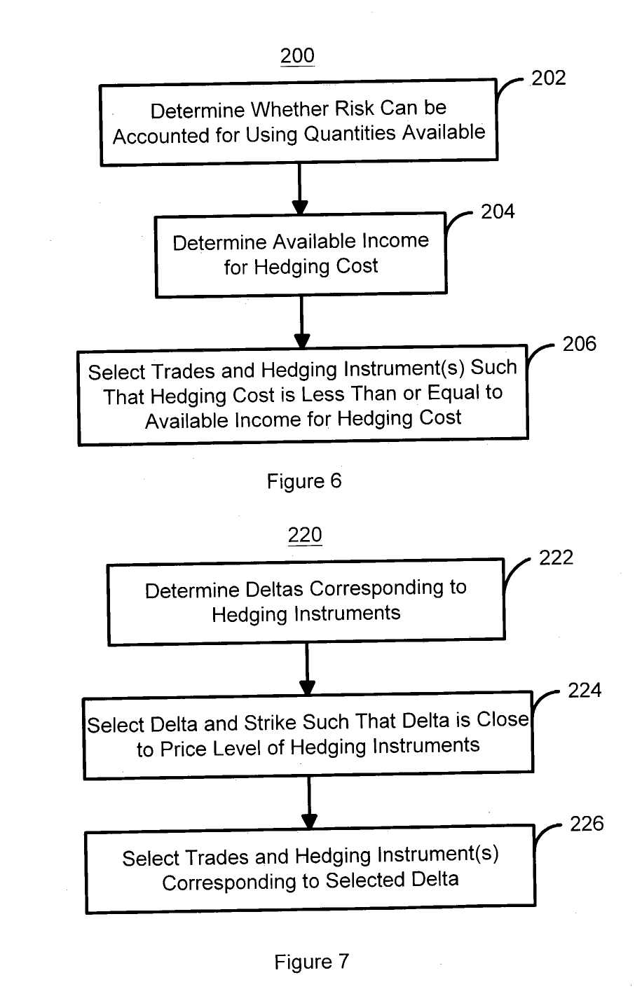

FIG. 6 is a flow chart depicting one embodiment of a method 200 in accordance with the present invention for managing risks based on adjustment in risks between systems by adjusting the strike. The method 200 is preferably implemented by the SPV 100, 100′ and/or by the server 105. The method 200 preferably operates on contracts within the complete set of contracts described above and in the above-identified co-pending patent applications. Consequently, the complete set of contracts can be exchanged for at least the settlement value regardless of whether any of the contracts actually matures. Thus, even if none of the contracts is deemed a winner, the complete set can be exchanged for at least the settlement value, at least for a particular amount of time. The winning contracts also guarantees a value, termed a notional, upon maturing. In one embodiment, the notional is equal to the initial settlement value (the settlement value prior to the interest rate being accounted for). In a preferred embodiment, the notional is equal to the settlement value. For clarity, the method 200 is described in the context of the SPV 100 and the systems 102, 103 and 104, depicted in FIG. 1A. However, the method 200 is fully applicable to the systems such as those described in FIGS. 1B and 1C.

Referring to FIGS. 1A and 6 the method 200 may be used when quantity matching between systems is not possible. For example, the methods 110, 130, 130′, 150, and 170 have been described in the context of performing matching trades the quantity ratio of one contract type (e.g. USD contract) to the other type (e.g. Yen contract) is based on current exchange rate (or the nearest integer). However, the ability of the complete set of contracts to be exchanged for the settlement value means the maximum risk for contracts (up to complete set) would be limited to initial settlement value. Therefore, a hedging instrument, such as an option with a strike equal to the quantity ratio will be able to manage the risk due to adjustments between systems, such as exchange rates. In other words, if the price difference of contracts (after considering the quantities available) is favorable enough, matching trade can be done by selecting a quantity ratio (and therefore FX option strike, as they must be equal) that can be different from the current exchange rate.

It is optionally determined whether it is possible to account for the risk differentials using the quantities in the market, via step 202. Step 202 is preferably used because the methods 110, 130, 130′, 150, and 170 may be more desirable (and simpler) to use where it is possible to account for the risk using the quantities available. In a preferred embodiment, step 202 includes determining whether the quantities available can account for the exchange rate. The available hedging cost is determined, via step 204. Step 204 preferably includes determining the income (if any) from performing certain trades in the systems. If the income is greater than zero, some profit is available for hedging costs. Thus, step 204 effectively determines the amount available to pay for hedging costs. The trades and hedging instruments are selected such that the hedging cost is less than or equal to the amount available for hedging cost, via step 206. The trades and hedging instruments selected depend upon the desired outcome. In one embodiment, the trades and hedging instrument are simply selected so that the profit is greater than or equal to zero (the amount available for hedging costs is, at most, exhausted). Thus, the price of the hedging instrument(s) would be checked to determine that they do not exceed the profit. In another embodiment, the trade and hedging instruments selected increase and preferably maximize the trading volume. In yet another embodiment, the trades and hedging instruments are selected to increase and, preferably, maximize the profits.

For example, suppose there is a bid of one lot of USD contract C1 with a price of US$50 at NYSE. There is also an offer of one hundred fifteen lots of Yen contract C1 with price forty-seven yen at TSE. Further suppose the current USD/Yen exchange rate is one hundred twenty. The quantity available for yen contract is apparently insufficient to perform risk management previously described. In other words the quantity of yen contracts (one hundred fifteen) is less than the current exchange rate (one hundred twenty). However, given the design of USD and Yen contract, matching trade is possible, depending on price of hedging instrument: performing step 204 determines a profit of: 1×50−115×47/120=US$4.958. Thus, a maximum of $4.958 is available to pay hedging costs. So long as the hedging cost is less than or equal to US$4.958, matching trade can still be performed. The implication is that the possibilities of matching trades are increased. Under more situations would trades be possibly done, or conditionally offered, leading to better liquidity.

In one embodiment the trades and hedging instruments are selected merely so that the amount available ($4.958) is at most exhausted. Suppose that there is a bid of one USD contract C1 and offer of 107 yen contract C1. Step 202 indicates that the quantity ratio available (one hundred fifteen) appears insufficient (one hundred twenty required). In step 206, the pricing of hedging instrument would be checked. If the price differential of USD and Yen contracts is large enough and/or the price of FX option for such quantity ratio is low enough, matching trade would still be possible. Thus, the hedging instrument would be bought and the trades performed in step 206.

In the embodiment where trading volume is increased, suppose there is an offer of one USD contract C1 and bid of two hundred yen contract C1. If the objective is to improve and preferably maximize the trading volume possible, different ratios would be tested in step 106 until the profit before hedging cost is no longer sufficient to cover the increasing hedging cost. For a matching trade of long USD contract/short yen contract, a hedging instrument of USD put/yen call can be used. The price of such a hedging instrument increases with the increase of strike. Suppose the current exchange rate is one hundred twenty. Given the quantity available for yen contract is two hundred, the quantity of matching trade may increase to a ratio of, say, one hundred twenty seven when the profit before hedging cost is equal to or marginally larger than price of a hedging instrument with a strike of one hundred twenty-seven. If the ratio were pushed to one hundred twenty-eight the former will be less than the latter (of strike now one hundred twenty-eight). Therefore, instead of one USD contract and one hundred twenty yen contracts, now one USD and one hundred twenty-seven yen contracts would be traded. Liquidity is, therefore, increased.

In the embodiment where profit is increased, suppose the quantity ratio at current exchange ratio meaning profit before hedging cost is insufficient to buy the hedging instrument. There is indeed a strike that the (profit before hedging cost—cost of FX option), or profit would be maximized. This strike is determined in step 206. To understand this, consider that for the long USD contract/short yen contract example, the money required to long USD contract is the cost and short yen contract is the revenue. The more yen contracts that can be shorted, the higher the revenue, but the higher the hedging cost as hedging instrument will have a higher strike (for USD put/yen call) and, therefore, a higher price. There will be a break-even point when marginal revenue of selling an additional yen contract equal to the marginal cost of buying a hedging instrument of higher strike. The marginal revenue is related to the yen contract market price. The marginal cost of an FX option is illustrated below in Tables 1, 2, and 3 using pricing model by Bloomberg:

TABLE 1

| USD/JPY current | |
|---|---|
| exchange rate | 120 |
| Maturity | 30 Days |
| Option | USD Put/JPY Call |

TABLE 2

| | | Option price | Hedging Cost (H) | | H - Duff from H at |
|---|---|---|---|---|---|
| | | as % of | per USD contract | | Current exchange |
| | Strike | Notional | in USD | in JPY | rate 120 (in JPY) |
| (Current | 118 | 0.571% | 0.571 | 68.52 | (81.60) |
| exchange | 119 | 0.868% | 0.868 | 104.16 | (45.96) |
| rate) | 120 | 1.251% | 1.251 | 150.12 | 0.00 |
| | 121 | 1.721% | 1.721 | 206.52 | 56.40 |
| | 122 | 2.269% | 2.269 | 272.28 | 122.16 |
| | 123 | 2.881% | 2.881 | 345.72 | 195.60 |

TABLE 3

| (a) | (b) | | | |
|---|---|---|---|---|
| H-Diff from H at | Strike-Diff from | | | |
| Current exchange rate | Current exchange | | | |
| 120 (in JPY) | rate 120 | (a)/(b) | Strike | |
| 81.60 | | 40.80 | 118 | |
| 45.96 | | 45.96 | 119 | |
| 0.00 | 0 | N/A | 120 | (Market rate) |
| 56.40 | 1 | 56.40 | 121 | |
| 122.16 | 2 | 61.08 | 122 | |
| 195.60 | 3 | 65.20 | 123 | |

Assuming the contract price is 61.50 yen for all of two hundred lots, for profit maximization the strike one hundred twenty two would be chosen. This number is selected because the incremental hedging cost of 61.08 yen is close to and slightly less than the incremental revenue of selling more yen contracts, which is at 61.50 yen per contract. Note that a maximized profit (after hedging cost) may still be negative, meaning matching trade cannot be done. However, by exploring different strikes, matching trade may be made possible. Liquidity is therefore potentially improved.

FIG. 7 is a flow chart depicting one embodiment of a method 220 in accordance with the present invention for managing risks based on adjustment in risks between systems by adjusting the strike and keeping delta neutral. Thus, the method 220 is termed the delta-neutral strike adjustment method. As used herein, the delta is the sensitivity of the price of the hedging instrument (e.g. an option) relative to the underlying asset (e.g. USD/Yen foreign exchange rate).

Given the strike adjustment method 200, in performing processes such as method 150 used in providing conditional orders, the quantity ratio (or quantities in each system) for systems of exchange rate differentials will be a matter of choice. One way to select the quantities is to calculate the incremental cost of the hedging instrument and generate incremental conditional orders according to such incremental hedging cost.

However, the key challenge can be the speed with which the hedging instrument is obtained given the possible volatility of exchange rate. The matching trade will require simultaneously double-checking the availability of matching trades and the hedging instrument (e.g. the option for exchange rates). Such risk management is especially desirable for conditional order offerings. To reduce the risk of not being able to obtain the hedging instrument at the expected or desired cost, the delta neutral strike adjustment method 220 can be adopted.

In the derivatives market, the delta of an option is the sensitivity of the option price (cost) relative to the underlying asset (i.e. USD/yen exchange rate in the case of USD/yen option). Such delta ranges from zero to one hundred percent (positive or negative depending on whether it is a USD call/yen put or USD put/yen call). Delta varies with the strike of the option. The strike and delta relationship can be generated by a standard option pricing model for options based on exchange rates, which is widely available to the market. Given a strike, the standard option pricing model will generate a delta value. Given a delta value, the standard pricing model will be able to generate a strike.

The delta(s) for the strike(s) of hedging instrument (e.g. option) are determined, via step 222. Select the delta and strike such that the corresponding delta is equal or close to the absolute price level of the contracts concerned (e.g. USD contract or Yen contract), via step 224. For example, if the USD contract is trading around US$71, strike of the option will be chosen such that the option delta is approximately seventy-one percent. Such a strike will then generate a quantity ratio for the purpose of generating conditional orders. Thus, the appropriate trades and hedging instrument(s) are selected using the selected delta, via step 226. The same technique can be applied for matching trades like method 130 to reduce the execution risk of buying FX option. Furthermore, delta from different contracts involving the same currency pair can be added. For example, if the USD contracts of CX1 and CX2 are trading around US$71 and US$9 respectively, strike of the option chosen such that the option delta can then be approximately eighty (80=71+9) percent. This is analogous to the situation of sharing of the hedging cost from different contracts as described above.

Note that delta-neutral or delta exchange is a standard method of option market trading. When market participants trade a hedging instrument such as an exchange rate option of, for example, USD put/yen call, the value of the option is highly sensitive to changes in current exchange rate of USD/yen. Both buyer and seller of such an option may not want to face the execution risk that exchange rate moves a great deal when the trade is negotiated but not yet completed. Therefore, a delta exchange trade involves two trades—an option buyer buying USD put/yen call of US$1 million notional will at the same time buy USD/sell yen of delta amount at exchange rate fixed at, say, market rate of 120. If the option delta is seventy-five percent, the delta amount for buy USD/sell yen at 120 will be seventy-five percent of the US$1 million notional, or US$0.75 million. The option seller will be the opposite side of the two trades. Therefore, if USD/yen suddenly moves up (e.g. from one hundred twenty to one hundred twenty one), the option buyer will have the option value dropping, which is compensated for by the increasing value of buy USD/sell yen at one hundred twenty. As the buy USD/sell yen amount is the delta amount representing the delta (therefore price sensitivity) of the option, the risk of an exchange rate move to the exchange rate option price is neutralized by the change in value of delta amount. For example, the loss of the exchange rate option value is about equal to the gain of buying a USD/sell yen exchange rate trade value, and vice versa if the USD/yen exchange rate moving down to, say, one hundred nineteen). Such a process of neutralizing the exchange rate risk is termed delta-neutral method.

When a matching trade is done, such as a buy USD contract and sell yen contract, the yen amount received from selling yen contract will be exchanged into USD for buying USD contract. Such an exchange of buy USD/sell yen is equivalent to delta amount and delta trade. Therefore, by selecting the price level of USD or yen contract as the option delta and thereby determining the strike of the option, the quantity ratio is determined by the option strike. For example if a USD contract is offered at $50, fifty percent is selected as the delta. Given this delta, a corresponding strike and a corresponding quantity are selected. The risk of executing the option (for example the risk due to volatile movement in USD/yen exchange rate) can therefore be reduced considerably.

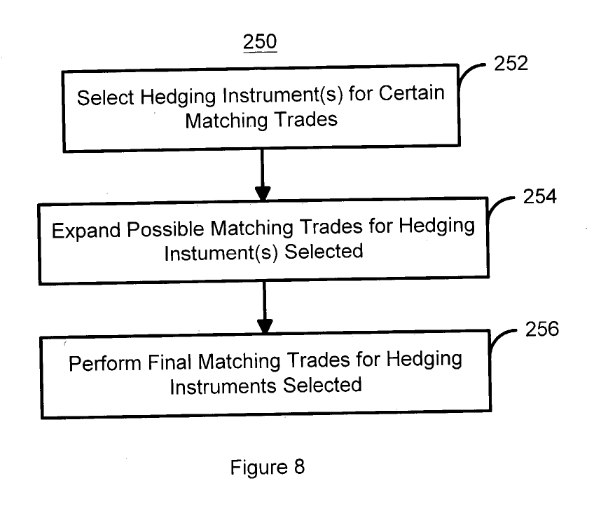

FIG. 8 is a flow chart depicting one embodiment of a method 250 in accordance with the present invention for managing risks based on adjustment in risks between systems by performing rolling of hedging instruments. A hedging instrument for certain matching trades (i.e. trades in different systems), is selected, via step 252. The choice of possible matching trades is extended, preferably using the criteria described below, via step 254. The final matching trades for the hedging instrument(s) are then performed, via step 256. Thus, the method 250 expands the choice of possible matching trades after a hedging instrument is bought with matching trade(s). As a result, trades may be performed in more situation and liquidity improved. This is accomplished by rebalancing quantity ratio of matching trades and rolling (selling old and buying new) hedging instrument simultaneously.

For example an exchange rate option cost analysis is restated as follows in Tables 4, 5, and 6:

TABLE 4

| USD/JPY current | |
|---|---|
| exchange rate | 120 |
| Maturity | 30 Days |
| Option | USD Put/JPY Call |

TABLE 5

| | | Option price | Hedging Cost (H) | | H - Duff from H at |
|---|---|---|---|---|---|
| | | as % of | per USD contract | | Current exchange |
| | Strike | Notional | in USD | in JPY | rate 120 (in JPY) |
| (Current | 118 | 0.571% | 0.571 | 68.52 | (81.60) |
| exchange | 119 | 0.868% | 0.868 | 104.16 | (45.96) |
| rate) | 120 | 1.251% | 1.251 | 150.12 | 0.00 |
| | 121 | 1.721% | 1.721 | 206.52 | 56.40 |
| | 122 | 2.269% | 2.269 | 272.28 | 122.16 |
| | 123 | 2.881% | 2.881 | 345.72 | 195.60 |

TABLE 6

| (a) | (b) | | | |
|---|---|---|---|---|
| H-Diff from H at | Strike-Duff from | | | |
| Current exchange rate | Current exchange | | | |
| 120 (in JPY) | rate 120 | (a)/(b) | Strike | |
| (81.60) | (2) | 40.80 | 118 | |
| (45.96) | (1) | 45.96 | 119 | |
| 0.00 | 0 | N/A | 120 | (Market rate) |
| 56.40 | 1 | 56.40 | 121 | |
| 122.16 | 2 | 61.08 | 122 | |
| 195.60 | 3 | 65.20 | 123 | |

Now consider the following example: suppose a matching trade has SPV 100 long one of USD contract C1, Short one hundred and twenty yen contract C1, and hold an exchange rate option USD put/yen call of strike one hundred and twenty. Suppose further there are zero bid and offer orders for any contracts except the following: Market bid of five yen contract C1 at a price of sixty-four yen each. The SPV 100 may perform the trade, therefore improving liquidity, by rebalancing quantity ratio of matching trades and rolling (selling old and buying new) hedging instrument simultaneously. The trades are: Trade 1-sell two yen contract C1 (at price sixty-four yen each); Trade 2-sell FX option USD put/yen call of strike one hundred twenty; and Trade 3-buy option for USD put/yen call of strike one hundred twenty two.

Trade 1 brings “revenue” of 2×64=128 yen (note that only two yen contracts will be sold though there are five bidding in the market, as the incremental hedging cost for moving to strike one hundred twenty three is 65.20 yen per contract (assume zero bid/offer spread for price of option), which is higher than the bid price of sixty-four yen). As a higher strike of the option USD put/yen call will always be more expensive, there will be net cost of Trades 2 and 3 together. If revenue from Trade 1 is equal to or greater than the net cost incurred by Trades 2 and 3 combined, the trades can be done. Liquidity is, therefore improved. Based on the same method, conditional orders can be generated.

Similarly, suppose a matching trade is done with the following the SPV 100 long one USD contract C1, short one hundred and twenty yen contract C1, holds a FX option USD put/yen call of strike one hundred twenty. Further suppose that there are zero bids and offers for any contracts except the following: the market offer of seven yen contract C1 at a price of forty-four yen. The SPV 100 may perform trade by rebalancing quantity ratio of matching trades and rolling (selling old and buying new) hedging instrument simultaneously: Trade A-buy one yen contract C1 (at price forty-four yen); Trade B-sell an option USD put/yen call at a of strike of one hundred twenty; Trade C-buy an option USD put/yen call of strike one hundred nineteen.

Trade A costs forty-four yen (note that only one yen contract will be bought though there are seven offerings in the market, as the incremental savings in hedging cost for moving to strike one hundred eighteen is 40.80 yen per contract, lower than the offer price of forty-four yen). As a lower strike of an option USD put/yen call will always be cheaper, there will be net income for Trades B and C together. If the cost of Trade A is equal to or less than the savings of Trades B and C combined, trade is done. Liquidity is, therefore improved. Based on the same method, conditional orders can be generated such as method 150.

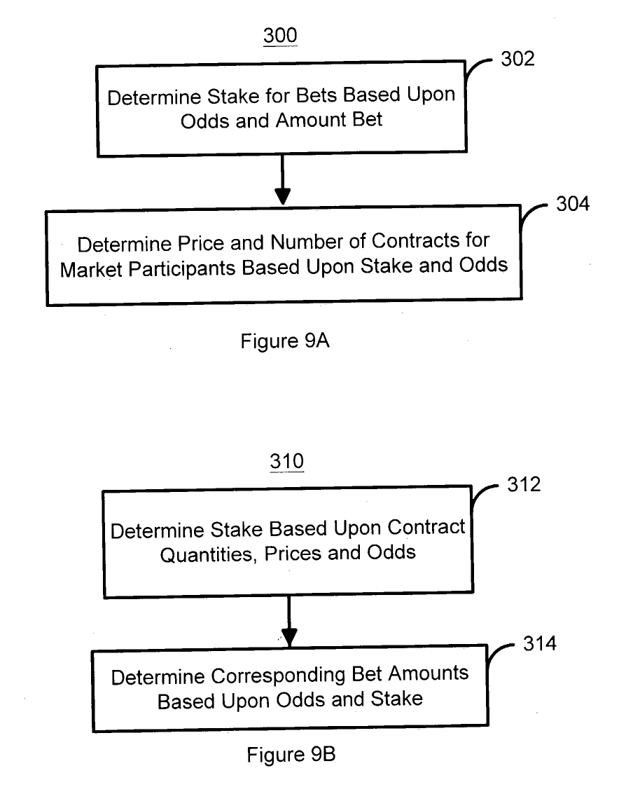

In addition, in accordance with the method and system described herein, different type of contracts, or orders, can be converted to a complete set of contracts. FIG. 9A depicts a high level flow chart of one embodiment of a method 300 in accordance with the present invention for converting other contracts into a complete set. The complete set of contracts is described above. For clarity, the method 300 is described in the context of betting. However, in an alternate embodiment, other financial instruments could be similarly converted. The bookmaker sets the odds prior to the method 300 commencing. Thus, it is assumed that the odds are known when the bets are converted to a complete set of contracts. In addition, it is assumed that the different outcomes are also known. Thus, a complete set would include each of the outcomes. For example, a complete set is to be formed for a horse race having five horses and the bets are on which horse wins, a complete set would include a bet to win on each of the five horses.

The total stakes for particular bets are determined based on the odds, via step 302. As described above, each bet is for a particular outcome, or contract in the complete set. In the example described above, assume that the odds are 5:1 for a particular horse and that a market participant has bet one dollar. Consequently, the stake is five dollars. The stake is the value of the contract(s) if the contract(s) held by the market participant are the winning contract. A number of contracts in the complete set and price per contract are determined for the bets based upon the stake, via step 304. Step 304 includes determining the value per contract if the contract wins, the corresponding number of contracts, and the price of the contract. The value per contract multiplied by the number of contracts held by the market participant equals the stake. In addition, the price is given by the value per contract divided by the odds. In the example above, the stake is five dollars. The exchange could decide that the contracts in the complete set are defined such that the value is one dollar per winning contract. Thus, step 304 would include dividing five dollars by one dollar per contract to give the number of contracts as five. The price per contract would be one dollar (value per contract) divided by the 5:1 (odds) for a price of twenty cents. Thus, using the method 300, bets can be converted into a complete set of contracts. One or more of the benefits of the method and system described herein can thus be achieved.

FIG. 9B depicts a high level flow chart of one embodiment of a method 310 in accordance with the present invention for converting contract orders into other financial instruments. Using the method 310, contract orders can be converted into the bet and odds format using the contract price and quantity. Thus, the method 310 can be viewed as the inverse of the method 300. The contracts are converted into a stake using the quantity and price, via step 312. Step 312 includes multiplying the number of contracts by their price and odds selected by the exchange or other organizer in order to obtain a stake. The stake is then converted into a bet and odds format using the odds, via step 314. Thus, the contracts in a complete set can be presented in a bet-odds format.

Consequently, using the methods 300 and 310, contracts in a complete set can be converted to a bet-odds format and vice versa. Information can thus be presented to market participants in either format (or both). Orders from both contract and bet formats can be combined and consolidated into one marketplace for presentation and trading.

A method and system has been disclosed for managing risks, such as exchange rate or credit risks. In addition to managing risk, additional profits could be obtained and liquidity improved. Software written according to the present invention is to be stored in some form of computer-readable medium, such as memory, CD-ROM or transmitted over a network, and executed by a processor. Consequently, a computer-readable medium is intended to include a computer readable signal which, for example, may be transmitted over a network. Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for managing risk for a plurality of contracts offered for trading in a plurality of systems, a contract of the plurality of contracts being offered for a trade in a first system, the method comprising the steps of:
determining whether a matching trade in a second system of the plurality of systems is possible, a rate differential existing between the first system and the second system, the rate differential resulting in a hedging cost between the first system and the second system for the contract, a complete set including the plurality of contracts, each of the plurality of contracts maturing upon at least one particular event occurring, the complete set guaranteeing at least an initial settlement at at least one particular time, the complete set corresponding to a settlement value, the settlement value being based upon the initial settlement value, a winning contract of the plurality of contracts paying a notional upon maturing;
determining whether conducting a portion of the trade and a portion of the matching trade is profitable; and
performing the portion of the trade and the portion of the matching trade if conducting the portion of the trade and the portion of the matching trade is profitable.

2. The method of claim 1 wherein the settlement value is determined based upon the initial settlement value and an interest rate effect, if necessary.

3. The method of claim 1 wherein the profitability determining step further includes the step of:
determining whether a profit from conducting the portion of the trade and a portion of the matching trade is greater than or equal to the hedging cost.

4. The method of claim 1 wherein the profitability determining step further includes the step of:
determining whether a profit from conduction the portion of the trade and the portion of the matching trade is at least an amount, the amount being less than the hedging cost by a particular amount.

5. The method of claim 1 wherein a quantity of the contract is offered for trade in the first system and wherein the profitability determining step further includes the steps of:
determining the portion of the matching trade based upon the rate differential and the quantity, the portion of the matching trade corresponding to a second quantity.

6. The method of claim 5 wherein the performing step further includes the step of:
performing the trade for a first quantity and the matching trade for the second quantity.

7. The method of claim 6 wherein the first quantity is equal to the quantity offered for trade.

8. The method of claim 7 wherein the trade performing step further includes the steps of:
accumulating the second quantity in the second system such that the second quantity corresponds to the first quantity.

9. The method of claim 1 wherein the trade is a bid to buy a quantity of the contract and the matching trade is an offer to sell the contract.

10. The method of claim 1 wherein the trade is an offer to sell a quantity of the contract and the matching trade is a bid to buy the contract.

11. The method of claim 1 further comprising the step of:
if the matching trade is possible but no corresponding offer and/or bid exists, providing a conditional order to trade in a third system, a second rate differential existing between the first system and the third system, the second rate differential resulting in a second hedging cost between the first system and the third system for the contract, the conditional order to trade having a condition, the condition being the trade taking place.

12. The method of claim 11 wherein the third system is the same the second system.

13. The method of claim 1 wherein the hedging cost is for at least one hedging instrument previously utilized in a prior transaction, thereby recycling the hedging cost.

14. The method of claim 1 wherein a portion of the plurality of contracts is offered for a second trade in a third system, the method further comprising the step of:
determining whether a second matching trade for at least one of the portion of the plurality of contracts is possible; and
performing at least a portion of the second trade and at least a portion of the matching trade if the at least the second trade and the at least the matching trade are profitable, thereby sharing the hedging cost.

15. The method of claim 14 wherein the notional is equal to the settlement value and wherein the hedging cost is determined based upon the settlement value.

16. The method of claim 14 wherein the portion of the plurality of contracts and the contract constitute at least one of the complete set of contracts.

17. The method of claim 1 wherein the notional is equal to the settlement value and wherein the hedging cost is determined based upon the settlement value.

18. The method of claim 1 wherein the profitability determining step further includes the step of:
determining a profit and the hedging cost for a plurality of values of the rate differential.

19. The method of claim 18 wherein the performing step further includes the step of:
performing the portion of the trade and the portion of the matching trade at a preferred value of the plurality of values of the rate differential if the profit is greater than or equal to the hedging cost.

20. The method of claim 1 wherein the plurality of systems corresponds to a plurality of currencies and wherein the rate differential is an exchange rate.

21. The method of claim 1 wherein the plurality of systems corresponds to a plurality of credit ratings and wherein the rate differential corresponds to different credit costs.

22. The method of claim 1 wherein the trade is a bid to buy, the method further comprising the step of:
determining whether the hedging cost plus the settlement value is less than or equal to a selling revenue obtained from selling the contract and a remaining portion of the plurality of contracts corresponding to at least one bid, if any;
obtaining the complete set for the settlement value; and
selling the contract and the remaining portion of the plurality of contracts, if any, if the selling revenue is greater than or equal to the hedging cost plus the settlement value.

23. The method of claim 1 wherein the trade is an offer to sell at a particular price, the method further comprising the step of:
determining whether the hedging cost plus the particular price plus a cost of a remaining portion of the plurality of contracts is less than or equal to the settlement value;
assembling the complete set by buying the contract and the remaining portion of the plurality of contracts, if required, if the hedging cost plus the particular price plus the cost is less than or equal to the settlement value; and
redeeming the complete set for the settlement value.

24. The method of claim 1, wherein the matching trade determining, profitability determining, and trade performing steps are performed using a computer system.

25. The method of claim 1 wherein the profitability determining step further includes the steps of:
determining an available income for at least one hedging instrument having at least one hedging cost; and
selecting the portion of the matching trade and a portion of the at least one hedging instrument if a portion of the at least one hedging cost is less than or equal to the available income.

26. The method of claim 1 wherein the profitability determining step further includes the steps of:
determining a plurality of deltas corresponding to a plurality of hedging instruments;
selecting a portion of the plurality of deltas close or equal to a cost of a portion of the plurality of contracts; and
performing at least one corresponding trade and obtaining the portion of the plurality of hedging instruments.

27. The method of claim 1 wherein the profitability determining step further includes the steps of:
selecting at least one hedging instrument corresponding to the matching trade;
expanding possible matching trades for the at least one hedging instrument; and
selecting the final trade based upon the at least one hedging instrument and the possible matching trades.

28. The method of claim 1 further comprising the step of:
converting a plurality of bets from a bet-odds format to the plurality of contracts.

29. The method of claim 1 further comprising the step of:
converting the plurality of contracts to a bet-odds format.

30. A method for managing risk for a plurality of contracts offered for trading in a plurality of systems, a contract of the plurality of contracts being offered for a trade in a first system, the method comprising the steps of:
determining whether it is profitable to individually sell the contract and a portion of the plurality of contracts, the portion of the plurality of contracts corresponding to at least one bid, if any, the at least one bid being in at least a second system, at least one rate differential existing between the first system and the at least the second system, the rate differential resulting in the at least one hedging cost between the first system and the at least the second system, a complete set including the plurality of contracts, the complete set guaranteeing at least an initial settlement value at at least one particular time, the complete set also corresponding to a settlement value, the settlement value being based upon the initial settlement value,;
obtaining the complete set of contracts, if individually selling the contract and the portion of the plurality of contracts is profitable; and
individually selling the contract and the portion of the plurality of contracts, if individually selling the contract and the portion of the plurality of contracts is profitable.

31. The method of claim 30 wherein the settlement value is determined based upon the initial settlement value and an interest rate effect, if necessary.

32. The method of claim 30 wherein the profitability determining step further includes the step of:
determining whether at least one hedging cost plus the settlement value is less than or equal to a selling profit obtained from selling the contract and the portion of the plurality of contracts.

33. A method for managing risk for a plurality of contracts offered for trading in a plurality of systems, a contract of the plurality of contracts being offered for a trade in a first system, the trade being an offer to sell at a particular price, the method comprising the steps of:
determining whether individually buying the contract at the particular price and a remaining portion of the plurality of contracts is profitable, the at least one bid being in at least a second system, at least one rate differential existing between the first system and the at least the second system, the rate differential resulting in the at least one hedging cost between the first system and the at least the second system, a complete set including the plurality of contracts, the complete set guaranteeing at least an initial settlement value at at least one particular time, the complete set also corresponding to a settlement value, the settlement value being based upon the initial settlement value, a winning contract of the plurality of contracts paying a notional upon maturing;
assembling the complete set by buying the contract and the remaining portion of the plurality of contracts, if required, if individually buying the contract and the remaining portion of the plurality of contracts and exchanging the complete set is profitable; and
exchanging the complete set for the settlement value, if profitable.

34. The method of claim 33 wherein the settlement value is determined based upon the initial settlement value and an interest rate effect, if necessary.

35. The method of claim 33 wherein the profitability determining step further includes the step of:
determining whether at least one hedging cost plus the particular price plus cost of the remaining portion of the plurality of contracts is greater than or equal to the settlement value.

36. A computer-readable medium containing a program for managing risk for a plurality of contracts offered for trading in a plurality of systems, a contract of the plurality of contracts being offered for a trade in a first system, the program including instructions for:
determining whether a matching trade in a second system of the plurality of systems is possible, a rate differential existing between the first system and the second system, the rate differential resulting in a hedging cost between the first system and the second system for the contract, a complete set including the plurality of contracts, the complete set guaranteeing at least an initial settlement value at at least one particular time, the complete set also corresponding to a settlement value, the settlement value being based upon the initial settlement value, a winning contract of the plurality of contracts paying a notional upon maturing;
determining whether conducting a portion of the trade and a portion of the matching trade is profitable; and
performing the portion of the trade and the portion of the matching trade if conducting the portion of the trade and the portion of the matching trade is profitable.

37. The computer-readable medium of claim 36 wherein the profitability determining instructions further includes instructions for:
determining whether a profit from conducting a portion of the trade and a portion of the matching trade is greater than or equal to the hedging cost.

38. The computer-readable medium of claim 36 wherein the plurality of systems corresponds to a plurality of currencies and wherein the rate differential is an exchange rate.

39. The computer-readable medium of claim 36 wherein the plurality of systems corresponds to a plurality of credit ratings and wherein the rate differential corresponds to different credit costs.

40. A computer-readable medium containing a program for managing risk for a plurality of contracts offered for trading in a plurality of systems, a contract of the plurality of contracts being offered for a trade in a first system, the program including instructions for:
determining whether it is profitable to individually sell the contract and a portion of the plurality of contracts, the portion of the plurality of contracts corresponding to at least one bid, if any, the at least one bid being in at least a second system, at least one rate differential existing between the first system and the at least the second system, the rate differential resulting in the at least one hedging cost between the first system and the at least the second system, the complete set guaranteeing at least an initial settlement value at at least one particular time, the complete set also corresponding to a settlement value, the settlement value being based upon the initial settlement value, a winning contract of the plurality of contracts paying a notional upon maturing;
obtaining the complete set of contracts, if individually selling the contract and the portion of the plurality of contracts is profitable; and
individually selling the contract and the portion of the plurality of contracts, if individually selling the contract and the portion of the plurality of contracts is profitable.

41. A computer-readable medium containing a program for managing risk for a plurality of contracts offered for trading in a plurality of systems, a contract of the plurality of contracts being offered for a trade in a first system, the trade being an offer to sell at a particular price, the program containing instructions for:
determining whether individually buying the contract at the particular price and a remaining portion of the plurality of contracts is profitable, the at least one bid being in at least a second system, at least one rate differential existing between the first system and the at least the second system, the rate differential resulting in the at least one hedging cost between the first system and the at least the second system, a complete set including the plurality of contracts the complete set guaranteeing at least an initial settlement value at at least one particular time, the complete set also corresponding to a settlement value, the settlement value being based upon the initial settlement value, a winning contract of the plurality of contracts paying a notional upon maturing;
assembling the complete set by buying the contract and the remaining portion of the plurality of contracts, if required, if individually buying the contract and the remaining portion of the plurality of contracts and exchanging the complete set is profitable; and
exchanging the complete set for the settlement value, if profitable.

42. The computer-readable medium of claim 41 wherein the profitability determining instructions further includes instructions for:
determining whether at least one hedging cost plus the particular price plus cost of the remaining portion of the plurality of contracts is greater than or equal to the settlement value.

43. A special purpose vehicle (SPV) for managing risk for a plurality of contracts offered for trading in a plurality of systems, a contract of the plurality of contracts being offered for a trade in a first system, the SVP comprising:
means for determining whether a matching trade for the contract in a second system of the plurality of systems is possible, a rate differential existing between the first system and the second system, the rate differential resulting in a hedging cost between the first system and the second system for the contract, a complete set including the plurality of contracts, the complete set guaranteeing at least an initial settlement value at at least one particular time, the complete set also corresponding to a settlement value, the settlement value being based upon the initial settlement value, a winning contract of the plurality of contracts paying a notional upon maturing;
means, coupled with the matching trade determining means, for determining whether conducting a portion of the trade and a portion of the matching trade is profitable; and
means, coupled with the profit determining means, for performing the portion of the trade and the portion of the matching trade, if the profitable.

44. The SPV of claim 43 wherein the profitability determining means further determine whether a profit from conducting a portion of the trade and a portion of the matching trade is greater than or equal to the hedging cost.

45. A special purpose vehicle (SPV) for managing risk for a plurality of contracts offered for trading in a plurality of systems, a contract of the plurality of contracts being offered for a trade in a first system, the SPV comprising:
means for determining whether it is profitable to individually sell the contract and a portion of the plurality of contracts, the portion of the plurality of contracts corresponding to at least one bid, if any, the at least one bid being in at least a second system, at least one rate differential existing between the first system and the at least the second system, the rate differential resulting in the at least one hedging cost between the first system and the at least the second system, a complete set including the plurality of contracts, the complete set guaranteeing at least an initial settlement value at at least one particular time, the complete set also corresponding to a settlement value, the settlement value being based upon the initial settlement value and an interest rate effect, if any, a winning contract of the plurality of contracts paying a notional upon maturing;
means for obtaining the complete set of contracts, if it is profitable to individually sell the contract and the portion of the plurality of contracts; and
means for individually selling the contract and the portion of the plurality of contracts, if it is profitable to individually sell the contract and the portion of the plurality of contracts.

46. A special purpose vehicle (SPV) for managing risk for a plurality of contracts offered for trading in a plurality of systems, a contract of the plurality of contracts being offered for a trade in a first system, the trade being an offer to sell at a particular price, the SPV comprising:
means for determining whether individually buying the contract at the particular price and a remaining portion of the plurality of contracts is profitable, the at least one bid being in at least a second system, at least one rate differential existing between the first system and the at least the second system, the rate differential resulting in the at least one hedging cost between the first system and the at least the second system, a complete set including the plurality of contracts, the complete set guaranteeing at least an initial settlement value at at least one particular time, the complete set also corresponding to a settlement value, the settlement value being based upon the initial settlement value and an interest rate effect, if any, a winning contract of the plurality of contracts paying a notional upon maturing;
means for assembling the complete set by individually buying the contract and the remaining portion of the plurality of contracts, if required, if it is profitable to individually buy the contract and the remaining portion of the plurality of contracts; and
means for exchanging the complete set for the settlement value, if it is profitable to individually buy the contract and the remaining portion of the plurality of contracts and exchange the contract and the remaining portion if the plurality of contracts for the settlement value.
